(19) United States
(12) Patent Application Publication
(10) Pub. No.: US 2004/0136073 A1
(43) Pub. Date: Jul. 15, 2004

(54) Transmitted type diffractive optical element

(75) Inventors: Manabu Shiozaki, Yokohama-shi (JP); Masakazu Shigehara, Yokohama-shi (JP); Tomomi Sano, Yokohama-shi (JP); Makoto Katayama, Yokohama-shi (JP); Michiko Takushima, Yokohama-shi (JP); Hiroshi Suganuma, Yokohama-shi (JP)

Correspondence Address: MCDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/684,590

(22) Filed: Oct. 15, 2003

Related U.S. Application Data
(60) Provisional application No. 60/422,847, filed on Nov. 1, 2002.
(60) Provisional application No. 60/445,840, filed on Feb. 10, 2003.

(30) Foreign Application Priority Data
Nov. 1, 2002 (JP) P2002-320481
Feb. 10, 2003 (JP) 2003-032896

(51) Int. Cl. G02B 5/18

(52) U.S. Cl. 359/569; 359/566

(57) ABSTRACT

A transmitted type diffractive optical element comprises a transparent plate made of a material having a refractive index n₂, whereas the transparent plate is in contact with a medium having a refractive index n₁. A number of projections are arranged with a period L on the first surface side of the transparent plate. Each projection has a rectangular cross section with a height H and a width W. An antireflection layer is formed on the second surface of the transparent plate. When the light L1 having a wavelength λ is incident on the first surface at an incident angle θ, the transmitted type diffractive optical element satisfies (2n₁L/λ)sin θ=1, and n₂/n₁≦3 sin θ, whereas each of the diffraction efficiencies of transmitted first-order diffracted light L3₁ in TE and TM polarization modes is at least 0.8.

### CROSS-REFERENCE TO RELATED APPLICATIONS

This application claims the benefit of the claiming priority of U.S. Provisional application Ser. No. 60/422,847, filed on Nov. 01, 2002, and U.S. Provisional application Ser. No. 60/445,840, filed on Feb. 10, 2003, which provisional application is incorporated by reference herein.

### BACKGROUND OF THE INVENTION

1. Field of the Invention

The present invention relates to a transmitted type diffractive optical element.

2. Related Background Art

Diffractive optical elements are used for demultiplexing/multiplexing wavelengths of light in general. Known as transmitted type diffractive optical elements are those provided with multilevel periodic gratings. The efficiency of diffracting light incident on the transmitted type diffractive optical device has been evaluated separately in TE and TM polarization modes by rigorous coupled-wave analysis (hereinafter referred to as RCWA). (See, for example, Keiko Oka and two others, “Analysis of Diffractive Optical Element with Wavelength Region Using Rigorous Coupled-Wave Theory (RCWA)”, Journal of Japan Women's University, Faculty of Science, Vol. 10 (2002), pp. 99-108.)

### SUMMARY OF THE INVENTION

Though the transmitted type diffractive optical element described in the literature mentioned above yields a diffraction efficiency of 0.8 or greater in the TE polarization mode when the period L of the diffraction grating is on a par with the wavelength λ of incident light (L/λ<4.0), the diffraction efficiency in the TM polarization mode thereof fails to reach 0.8 and thus is at a practically insufficient level.

In order to overcome the problem mentioned above, it is an object of the present invention to provide a transmitted type diffractive optical element which can further enhance the diffraction efficiency in both of the TE and TM polarization modes.

The inventors conducted diligent studies concerning transmitted type diffractive optical elements which can improve the diffraction efficiency in both of the TE and TM polarization modes and, as a result, have newly found the following fact:

When the diffraction efficiency of diffracted light in transmitted type diffractive optical elements was analyzed by RCWA while changing various parameters under the condition where only zero- and first-order diffracted light components occur in the transmitted type diffractive optical elements, it was newly found that there was a combination of parameters by which the diffraction efficiency became 0.8 or greater in both of the TE and TM polarization modes. In view of such results of studies, the present invention has been achieved.

The present invention provides a transmitted type diffractive optical element comprising a transparent plate formed with a diffraction grating, the transparent plate having first and second surfaces parallel to each other; the first surface being in contact with a medium and formed with the diffraction grating, the second surface being provided with an antireflection film; wherein, when light is incident on the first surface of the transparent plate from the medium, there are a wavelength λ and an incident angle θ of the light satisfying the correlation expressions of (2n₁L/λ)sin θ=1 and n₂/n₁≦3 sin θ, where n₁ is the refractive index of the medium, n₂ is the refractive index in the first surface of the transparent plate (n₁<n₂), and L is the period of the diffraction grating; and wherein, at the wavelength λ and incident angle θ, transmitted first-order diffracted light in a TE polarization mode has a diffraction efficiency η_{TE} of at least 0.8, and transmitted first-order diffracted light in a TM polarization mode has a diffraction efficiency η_{TM} of at least 0.8. Preferably, the wavelength λ falls within a predetermined wavelength band whereas each of the diffraction efficiencies η_{TE} and η_{TM} is at least 0.8 in the whole predetermined wavelength band. In the specification and drawings, wavelengths refer to those in vacuum.

Preferably, each of the diffraction efficiencies η_{TE} and η_{TM} is at least 0.85 at the wavelength λ and incident angle θ. Preferably, the wavelength λ falls within a predetermined wavelength band whereas each of the diffraction efficiencies η_{TE} and η_{TM} is at least 0.85 in the whole predetermined wavelength band.

Preferably, each of the diffraction efficiencies η_{TE} and η_{TM} is at least 0.9 at the wavelength λ and incident angle θ. Preferably, the wavelength λ falls within a predetermined wavelength band whereas each of the diffraction efficiencies η_{TE} and η_{TM} is at least 0.9 in the whole predetermined wavelength band.

Preferably, the diffraction efficiencies η_{TE} and η_{TM} have a difference of 0.05 or less therebetween at the wavelength λ and incident angle θ. Preferably, the wavelength λ falls within a predetermined wavelength band whereas maximum and minimum values of the diffraction efficiencies η_{TE} and η_{TM} have a difference of 0.05 or less therebetween in the whole predetermined wavelength band.

Preferably, the diffraction efficiencies η_{TE} and η_{TM} have a difference of 0.025 or less therebetween at the wavelength λ and incident angle θ. Preferably, the wavelength λ falls within a predetermined wavelength band whereas maximum and minimum values of the diffraction efficiencies η_{TE} and η_{TM} have a difference of 0.025 or less therebetween in the whole predetermined wavelength band.

Preferably, the predetermined wavelength band includes C band, L band, or both C and L bands.

Preferably, the period L of the diffraction grating is 2.5 μm or less. Preferably, the wavelength λ falls within a wavelength band of 1.26 μm to 1.675 μm.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic view showing a cross-sectional configuration of the transmitted type diffractive optical element in accordance with an embodiment.

FIGS. 2A to 2C are contour maps showing results of simulation A.

FIGS. 3A to 3C are contour maps showing results of simulation A.

FIG. 4 is a contour map showing results of simulation A.

FIGS. 5A to 5C are contour maps showing results of simulation A.

FIGS. 6A to 6C are contour maps showing results of simulation A.

FIG. 7 is a chart showing the respective diffraction efficiencies η_{TE} and η_{TM} in TE and TM polarization modes obtained by simulation A.

FIG. 8 is a chart showing the respective diffraction efficiencies η_{TE} and η_{TM} in TE and TM polarization modes obtained by simulation A.

FIG. 9 is a chart showing the respective diffraction efficiencies η_{TE} and η_{TM} in TE and TM polarization modes obtained by simulation A.

FIG. 10 is a chart showing the respective diffraction efficiencies η_{TE} and η_{TM} in TE and TM polarization modes obtained by simulation A.

FIGS. 11A to 11C are contour maps showing results of simulation B.

FIGS. 12A to 12C are contour maps showing results of simulation B.

FIG. 13 is a contour map showing results of simulation B.

FIGS. 14A to 14C are contour maps showing results of simulation B.

FIGS. 15A to 15C are contour maps showing results of simulation B.

FIG. 16 is a chart showing the respective diffraction efficiencies η_{TE} and η_{TM} in TE and TM polarization modes obtained by simulation B.

FIG. 17 is a chart showing the respective diffraction efficiencies η_{TE} and η_{TM} in TE and TM polarization modes obtained by simulation B.

FIG. 18 is a chart showing the respective diffraction efficiencies η_{TE} and η_{TM} in TE and TM polarization modes obtained by simulation B.

FIG. 19 is a chart showing the respective diffraction efficiencies η_{TE} and η_{TM} in TE and TM polarization modes obtained by simulation B.

FIGS. 20A to 20C are contour maps showing results of simulation C.

FIGS. 21A to 21C are contour maps showing results of simulation C.

FIG. 22 is a contour map showing results of simulation C.

FIGS. 23A to 23C are contour maps showing results of simulation C.

FIGS. 24A to 24C are contour maps showing results of simulation C.

FIG. 25 is a chart showing the maximum value ηₘₐₓ and minimum value ηₘᵢₙ of diffraction efficiency obtained by simulation C.

FIG. 26 is a chart showing the maximum value ηₘₐₓ and minimum value ηₘᵢₙ of diffraction efficiency obtained by simulation C.

FIG. 27A is a graph showing relationships between η_{TE}, η_{TM} and wavelength in No. 8 in simulation C.

FIG. 27B is a graph showing relationships between η_{TE}, η_{TM} and wavelength in No. 55 in simulation C.

FIG. 28 is a chart showing the respective diffraction efficiencies η_{TE} and η_{TM} in TE and TM polarization modes obtained by simulation D.

FIG. 29 is a chart showing the respective diffraction efficiencies η_{TE} and η_{TM} in TE and TM polarization modes obtained by simulation D.

FIG. 30 is a chart showing the respective diffraction efficiencies η_{TE} and η_{TM} in TE and TM polarization modes obtained by simulation D.

FIG. 31 is a chart showing the respective diffraction efficiencies η_{TE} and η_{TM} in TE and TM polarization modes obtained by simulation D.

FIG. 32 is a chart showing the respective diffraction efficiencies η_{TE} and η_{TM} in TE and TM polarization modes obtained by simulation D.

FIG. 33 is a chart showing the respective diffraction efficiencies η_{TE} and η_{TM} in TE and TM polarization modes obtained by simulation E.

FIG. 34 is a chart showing the respective diffraction efficiencies η_{TE} and η_{TM} in TE and TM polarization modes obtained by simulation E.

FIG. 35 is a chart showing the respective diffraction efficiencies η_{TE} and η_{TM} in TE and TM polarization modes obtained by simulation E.

FIG. 36 is a chart showing the respective diffraction efficiencies η_{TE} and η_{TM} in TE and TM polarization modes obtained by simulation E.

FIG. 37 is a chart showing the respective diffraction efficiencies η_{TE} and η_{TM} in TE and TM polarization modes obtained by simulation E.

FIG. 38 is a chart showing the respective diffraction efficiencies η_{TE} and η_{TM} in TE and TM polarization modes obtained by simulation E.

FIG. 39 is a chart showing the respective diffraction efficiencies η_{TE} and η_{TM} in TE and TM polarization modes obtained by simulation E.

FIG. 40 is a chart showing the maximum value ηₘₐₓ and minimum value ηₘᵢₙ of diffraction efficiency obtained by simulation F.

FIG. 41 is a chart showing the maximum value ηₘₐₓ and minimum value ηₘᵢₙ of diffraction efficiency obtained by simulation F.

FIG. 42 is a chart showing the maximum value ηₘₐₓ and minimum value ηₘᵢₙ of diffraction efficiency obtained by simulation F.

FIG. 43 is a chart showing the maximum value ηₘₐₓ and minimum value ηₘᵢₙ of diffraction efficiency obtained by simulation F.

FIG. 44 is a chart showing the maximum value ηₘₐₓ and minimum value ηₘᵢₙ of diffraction efficiency obtained by simulation G.

FIG. 45 is a chart showing the maximum value ηₘₐₓ and minimum value ηₘᵢₙ of diffraction efficiency obtained by simulation G.

FIG. 46 is a chart showing the maximum value ηₘₐₓ and minimum value ηₘᵢₙ of diffraction efficiency obtained by simulation G.

FIG. 47 is a chart showing the maximum value ηₘₐₓ and minimum value ηₘᵢₙ of diffraction efficiency obtained by simulation G.

FIG. 48 is a chart showing the maximum value ηₘₐₓ and minimum value ηₘᵢₙ of diffraction efficiency obtained by simulation G.

FIG. 49 is a chart showing the maximum value ηₘₐₓ and minimum value ηₘᵢₙ of diffraction efficiency obtained by simulation G.

FIG. 50 is a chart showing the maximum value ηₘₐₓ and minimum value ηₘᵢₙ of diffraction efficiency obtained by simulation H.

FIG. 51 is a chart showing the maximum value ηₘₐₓ and minimum value ηₘᵢₙ of diffraction efficiency obtained by simulation H.

FIG. 52 is a chart showing the maximum value ηₘₐₓ and minimum value ηₘᵢₙ of diffraction efficiency obtained by simulation H.

FIG. 53 is a chart showing the maximum value ηₘₐₓ and minimum value ηₘᵢₙ of diffraction efficiency obtained by simulation H.

FIG. 54 is a chart showing the maximum value ηₘₐₓ and minimum value ηₘᵢₙ of diffraction efficiency obtained by simulation H.

FIG. 55 is a chart showing the maximum value ηₘₐₓ and minimum value ηₘᵢₙ of diffraction efficiency obtained by simulation H.

FIG. 56 is a chart showing the maximum value ηₘₐₓ and minimum value ηₘᵢₙ of diffraction efficiency obtained by simulation I.

FIG. 57 is a chart showing the maximum value ηₘₐₓ and minimum value ηₘᵢₙ of diffraction efficiency obtained by simulation I.

FIG. 58 is a chart showing the maximum value ηₘₐₓ and minimum value ηₘᵢₙ of diffraction efficiency obtained by simulation I.

FIG. 59 is a chart showing the maximum value ηₘₐₓ and minimum value ηₘᵢₙ of diffraction efficiency obtained by simulation I.

### DESCRIPTION OF THE PREFERRED EMBODIMENTS

In the following, embodiments of the present invention will be explained in detail with reference to the accompanying drawings. In the explanation of the drawings, constituents identical to each other will be referred to with numerals identical to each other without repeating their overlapping descriptions.

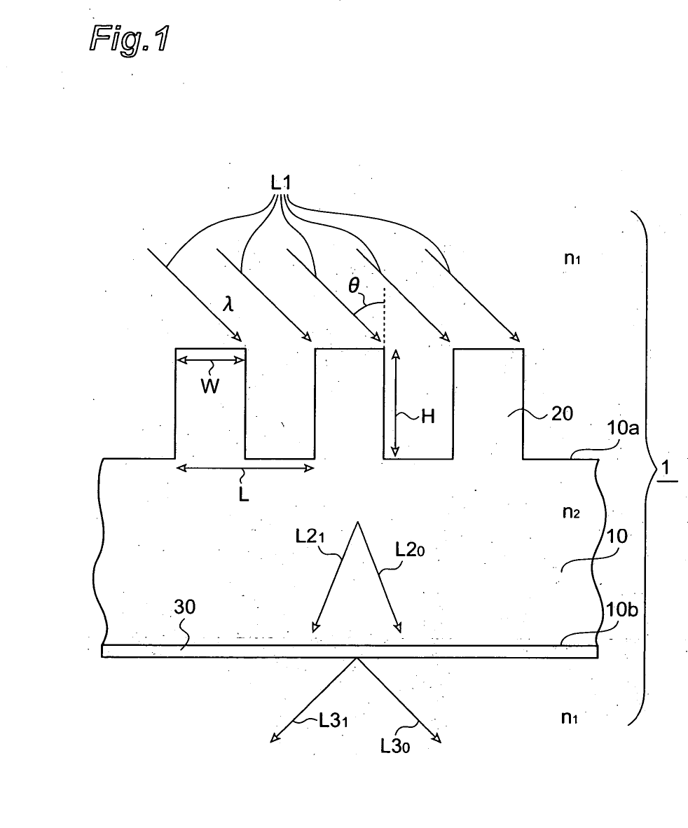

First, with reference to FIG. 1, the configuration of a transmitted type diffractive optical element 1 in accordance with an embodiment will be explained. FIG. 1 is a schematic view showing a cross-sectional configuration of the transmitted type diffractive optical element 1. The transmitted type diffractive optical element 1 comprises a transparent plate 10 having a first surface 10a and a second surface 10b which are parallel to each other. The transparent plate 10 is made of a material (e.g., glass, semiconductor, and organic materials) having a refractive index n₂, whereas a number of projections 20 are disposed with a period L on the first surface 10a, so as to form a diffraction grating. Each of the projections 20 has a rectangular cross section with a height H and a width W. An antireflection layer (hereinafter referred to as AR layer) 30 is formed on the second surface 10b of the transparent plate 10 (on the side opposite from the first surface 10a). Each of the first surface 10a and AR layer 30 is in contact with a medium (e.g., vacuum, gas such as air, liquid, or organic material) having a refractive index n₁ (<n₂).

Suppose that light L1 having a wavelength λ is incident on the first surface 10a of the transparent plate 10 in this transmitted type diffractive optical element 1 from the medium at an incident angle θ. Here, assuming that a plurality of diffracted light components are incident on the AR layer 30 at respective incident angles from within the transparent plate 10, the AR layer 30 prevents only the incident diffracted light component at a predetermined incident angle from being reflected, whereby the diffracted light components incident on the AR layer 30 at the other incident angles are reflected by the AR layer 30, so as to generate multiple reflections between the first surface 10a and the AR layer 30, thereby adversely affecting the diffraction efficiency. Therefore, in order to keep the antireflection characteristic at the AR layer 30, the following two conditions are necessary.

First, for keeping the antireflection property at the AR layer 30, zero-order diffracted light L2₀ and first-order diffracted light L2₁ are required to have the same diffraction angle. The condition therefor is given by the following expression:

(2n₁L/λ)sin θ=1 (1)

Further, for keeping the antireflection property at the AR layer 30, it is necessary that no diffracted light other than the zero-order diffracted light L2₀ and first-order diffracted light L2₁ is generated in the transparent plate 10 having the refractive index n₂. The condition therefor is given by the following expression:

n₂/n₁≦3 sin θ(2)

Table 1 shows the maximum refractive index ratio (n₂/n₁) satisfying expression (2) for each incident angle θ.

TABLE 1

| | Max refractive | | Max refractive |
|---|---|---|---|
| Incident angle θ | index ratio | Incident angle θ | index ratio |
| (deg) | (n₂/n₁) | (deg) | (n₂/n₁) |
| 20 | 1.026 | 55 | 2.457 |
| 25 | 1.268 | 60 | 2.598 |
| 30 | 1.500 | 65 | 2.719 |
| 35 | 1.721 | 70 | 2.819 |
| 40 | 1.928 | 75 | 2.898 |
| 45 | 2.121 | 80 | 2.954 |
| 50 | 2.298 | | |

If θ, n₂/n₁, and n₁L/λ are adjusted so as to satisfy both expressions (1) and (2), only reflected zero-order diffracted light (not depicted), reflected first-order diffracted light (not depicted), zero-order diffracted light L2₀, and first-order diffracted light L2₁ occur when the light L1 is incident on the transmitted type diffractive optical element 1, whereby the antireflection property is maintained at the AR layer 30.

Using such a transmitted type diffractive optical element 1, the inventors carried out simulations by RCWA under the condition satisfying both expressions (1) and (2), thereby determining respective diffraction efficiencies of transmitted first-order diffracted light L3₁ in TE and TM polarization modes.

As parameters used for simulations by RCWA, the incident angle θ, the ratio n₂/n₁ between the respective refractive indexes of the transparent plate 10 and medium, the ratio n₁H/λ between the height H of projection 20 and the wavelength λ of light L1, and the ratio W/L between the width W and period L of projection 20 are chosen.

Here, n₂/n₁, W/L, and n₁H/λ are closely related to the diffraction efficiency. Changing n₂/n₁ can control the distribution of light after the light is incident on the region formed with the projections 20. Changing n₁H/λ can control the phase of light after the light is incident on the region formed with the projections 20.

On the other hand, the incident angle θ is closely related to the performance of separating/combining the wavelength λ. As the incident angle θ increases, the performance of separating/combining the wavelength λ becomes greater. Therefore, it will be sufficient if the incident angle θ is set appropriately in conformity to the wavelength separating/combining performance required.

Also, the law of similarity holds between the wavelength λ and parameters (L, H, W) having a dimension of the length of the transmitted type diffractive optical element 1. For example, if L, H, and W are doubled when the wavelength λ is doubled, the diffraction efficiency does not change. Therefore, in this embodiment, the height H of projection 20 having a dimension of the length is standardized (divided) by the wavelength λ/n₁ in the medium.

Preferably, the wavelength λ falls within the wavelength band of 1.26 to 1.675 μm. When the wavelength λ is within this range, the transmitted type diffractive optical element 1 can be used favorably as a wavelength separating device in optical communications.

Details of simulations will now be explained. In the following simulations, an arithmetic operation for outputting the minimum value from given values X, Y, Z, . . . will be referred to as “min(X, Y, Z, . . . )”, whereas an arithmetic operation for outputting the maximum value from given values X, Y, Z, . . . will be referred to as “max(X, Y, Z, . . . )”.

Simulation A

In simulation A, while changing the parameters (n₂/n₁, n₁H/λ, W/L, and θ) as follows, a simulation was carried out by using RCWA, so as to determine respective diffraction efficiencies η_{TE} and η_{TM} in TE and TM polarization modes of the transmitted first-order diffracted light L3₁. Namely, n₂/n₁ was changed within the range of 1.05 to 3.00 in increments of 0.05. n₁H/λ was changed within the range of 0 to 5.00 in increments of 0.05. W/L was changed within the range of 0 to 1.00 in increments of 0.02. θ was changed within the range of 25° to 80° in increments of 5°.

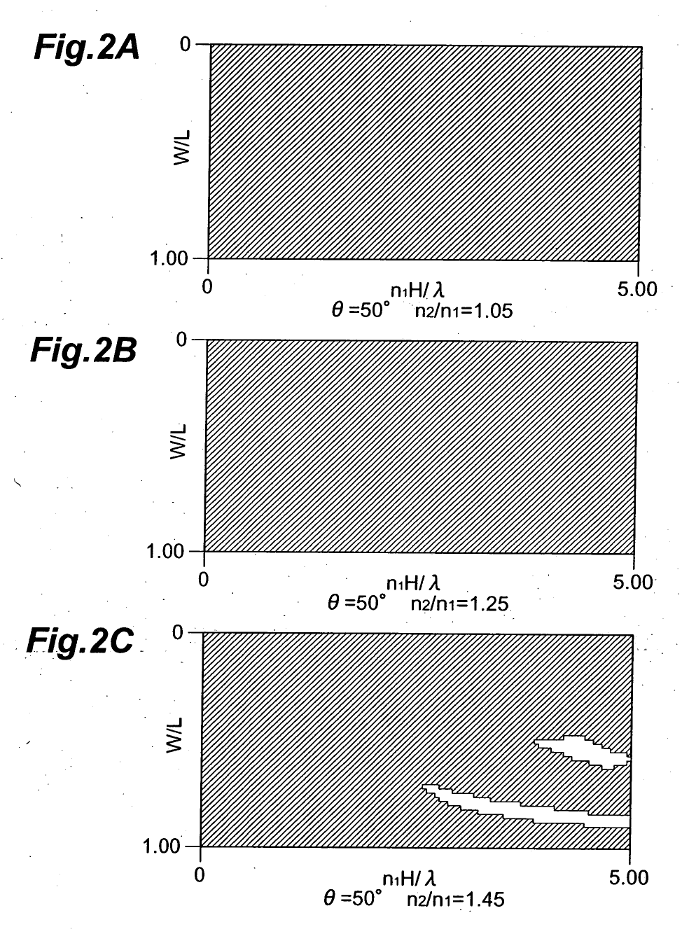

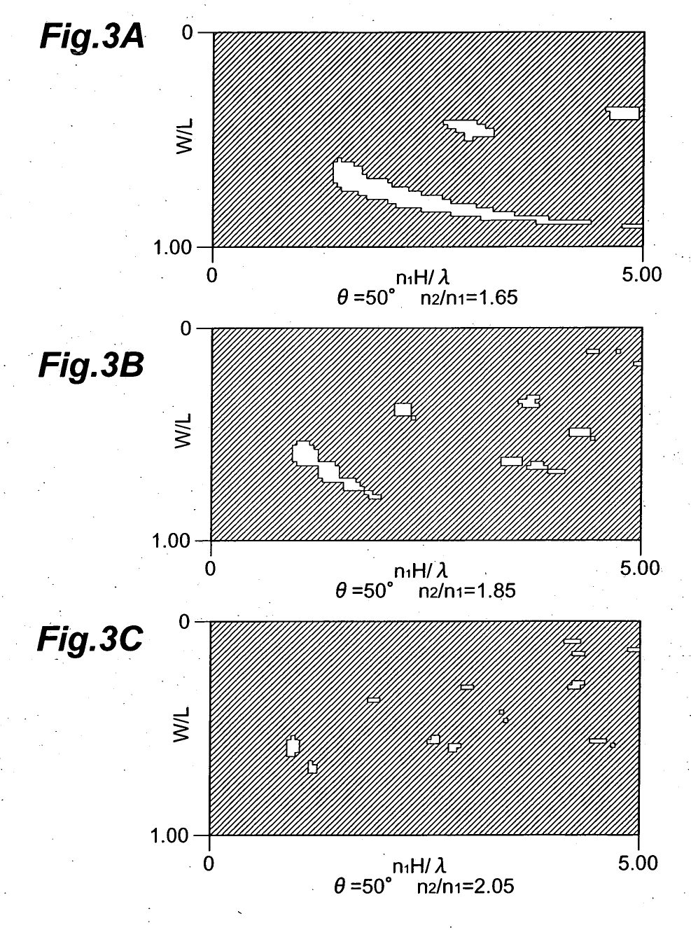

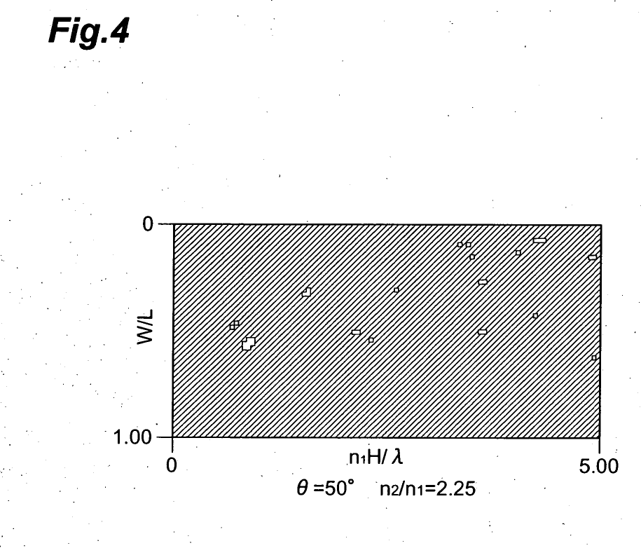

Then, within the range of parameters satisfying both expressions (1) and (2), combinations of parameters in which each of η_{TE} and η_{TM} becomes at least 0.8 are determined. Results thereof are partly shown as contour maps of diffraction efficiency in FIGS. 2A to 6C.

In each of these maps, the ordinate is W/L (0 to 1.00). In the ordinate, W/L=0 at the upper end whereas W/L=1.00 at the lower end. The abscissa is n₁H/λ (0 to 5.00). In the abscissa, n₁H/λ=0 at the left end whereas n₁H/λ=5.00 at the right end. On the lower side of each map, the values on the left and right indicate the incident angle θ and n₂/n₁, respectively.

FIGS. 2A to 4 are contour maps of η_{TE} and η_{TM} obtained when n₂/n₁ was changed from 1.05 to 2.25 in increments of 0.20 while setting θ at 50°. In the map, whitened parts (hereinafter referred to as white parts) indicate regions where both η_{TE} and η_{TM} become 0.8 or greater. Namely, the white parts in the maps satisfy the condition that min(η_{TE}, η_{TM})≧0.8. On the other hand, parts provided with hatching (hereinafter referred to as hatched parts) fail to satisfy the condition that min(η_{TE}, η_{TM})≧0.8.

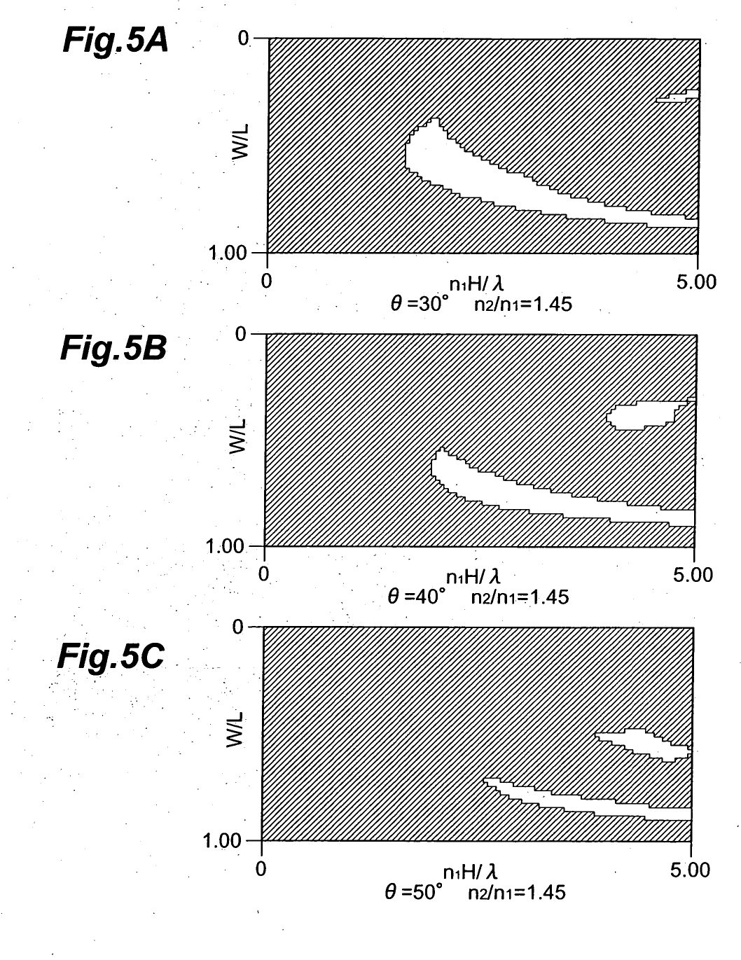

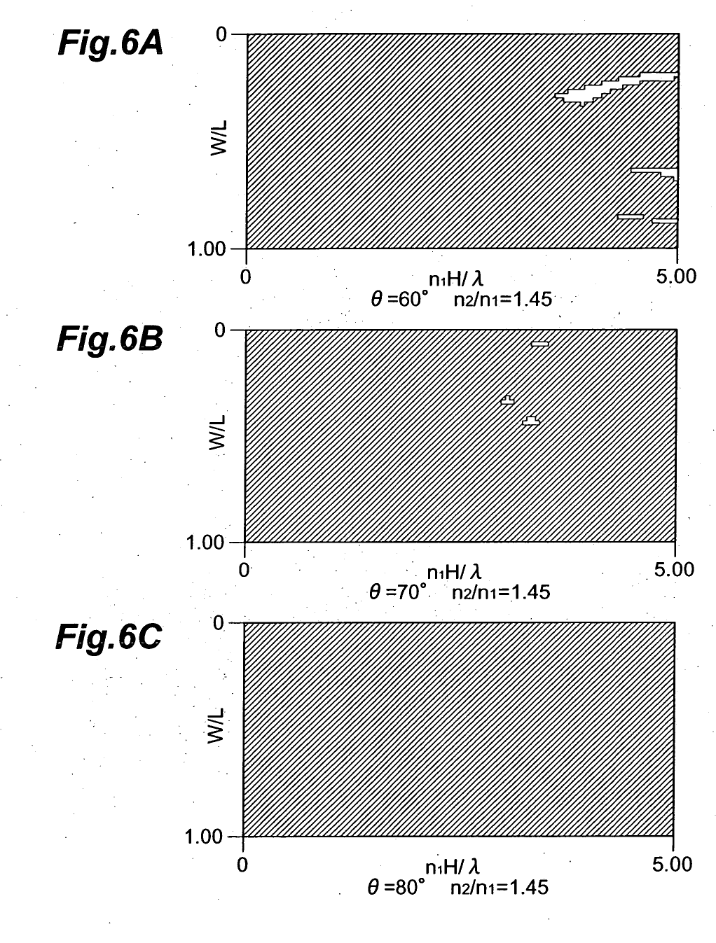

FIGS. 5A to 6C are contour maps of η_{TE} and η_{TM} obtained when θ was changed from 30° to 80° in increments of 10° while fixing n₂/n₁ at 1.45. The white parts in the maps indicate regions satisfying the condition that min(η_{TE}, η_{TM})≧0.8.

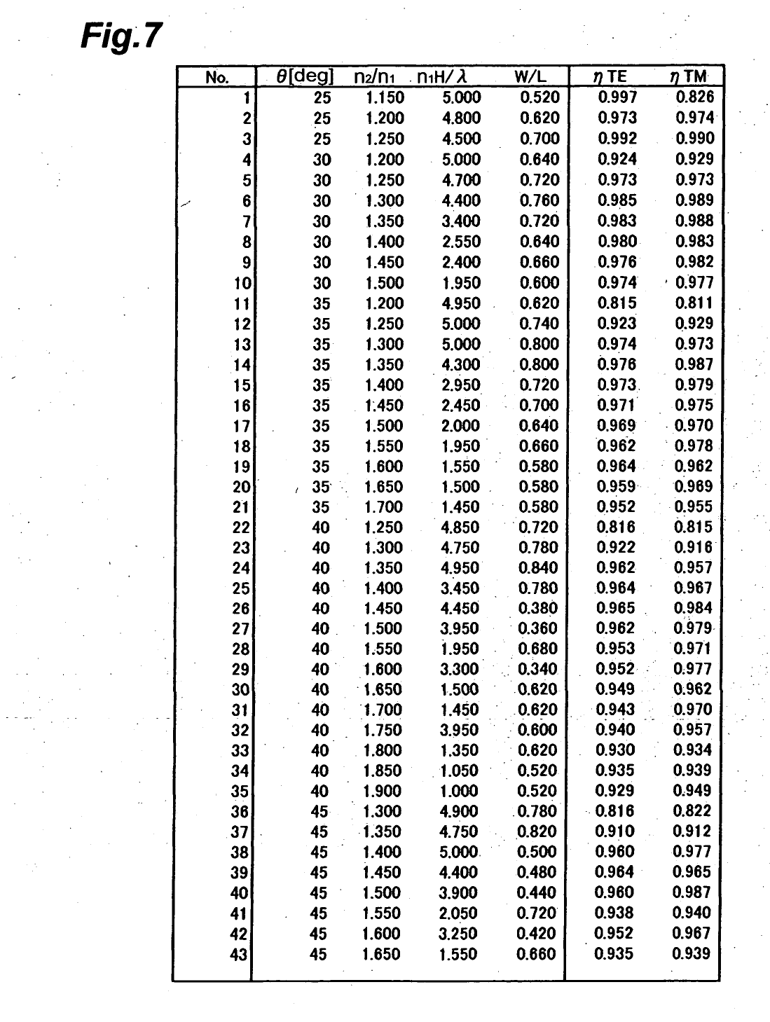

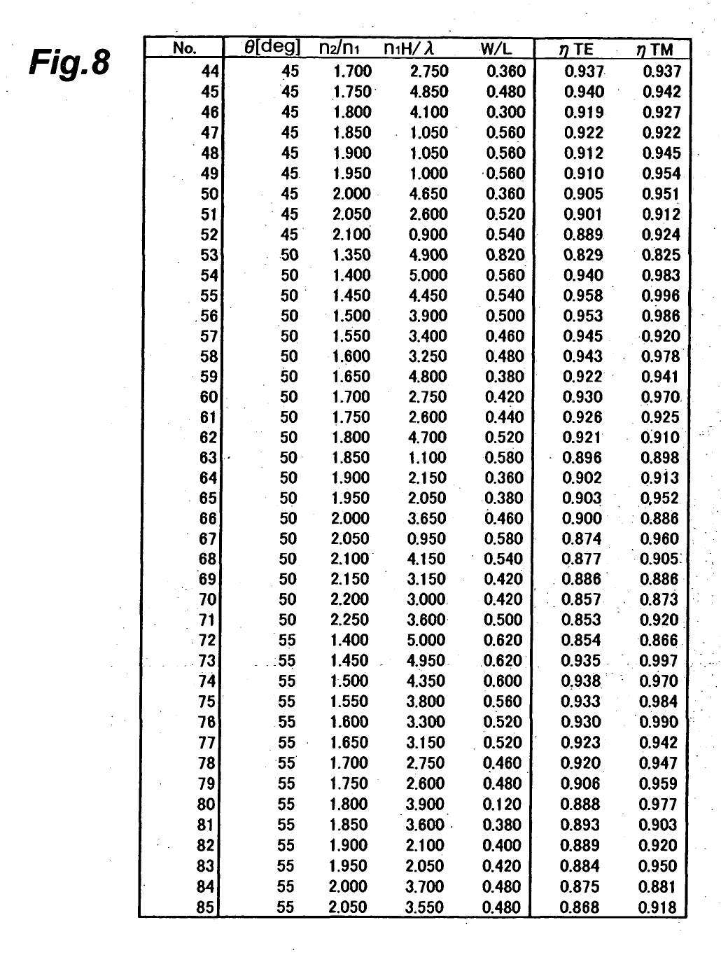

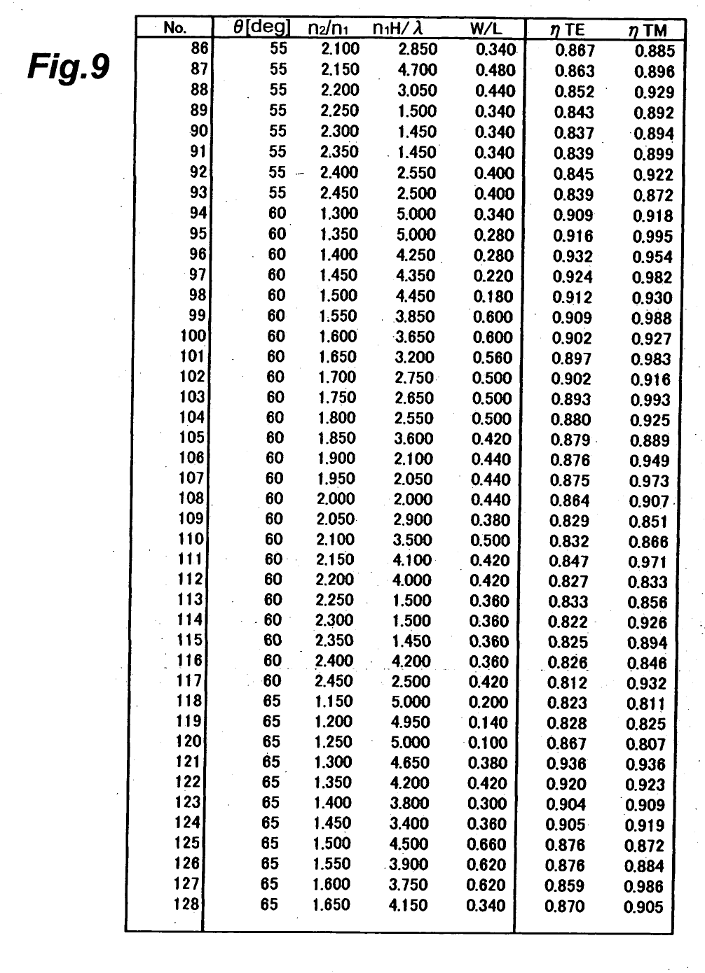

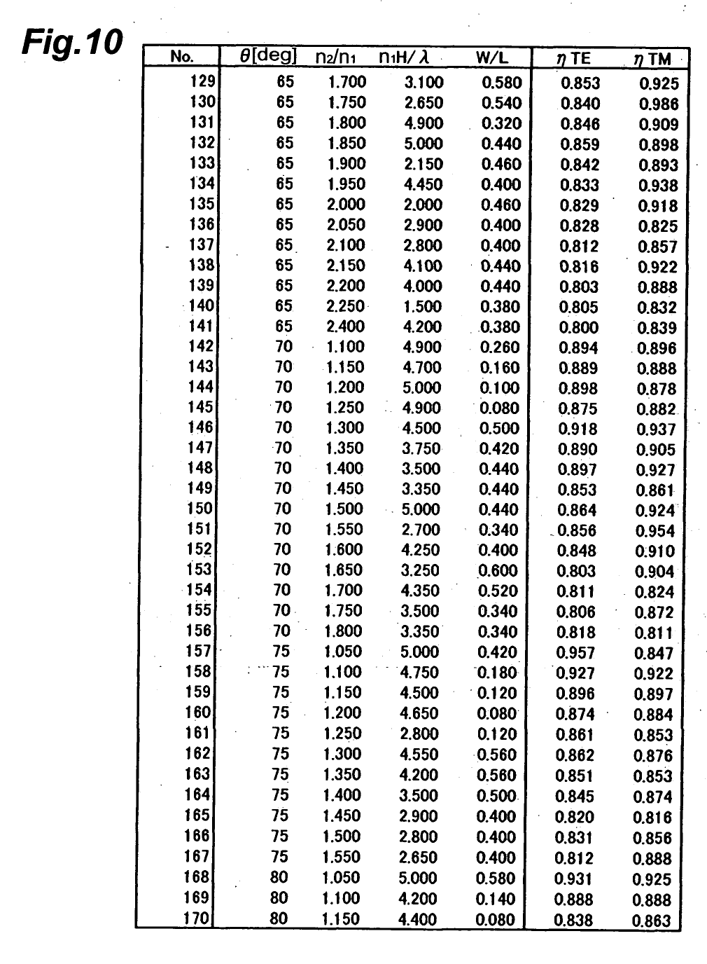

Regions where each of η_{TE} and η_{TM} becomes at least 0.8 also exist in combinations of parameters (n₂/n₁, n₁H/λ, W/L, and θ) other than those shown in FIGS. 2A to 6C under the condition satisfying both expressions (1) and (2). FIGS. 7 to 10 show values of the parameters n₂/n₁, n₁H/λ, W/L, and θ when min(η_{TE}, η_{TM}) attains the maximum value in these regions, and values of η_{TE} and η_{TM} at that time.

Thus, combinations of parameters in which each of the respective diffraction efficiencies in TE and TM polarization modes of the transmitted first-order diffracted light L3₁ became at least 0.8 were found in simulation A.

Simulation B

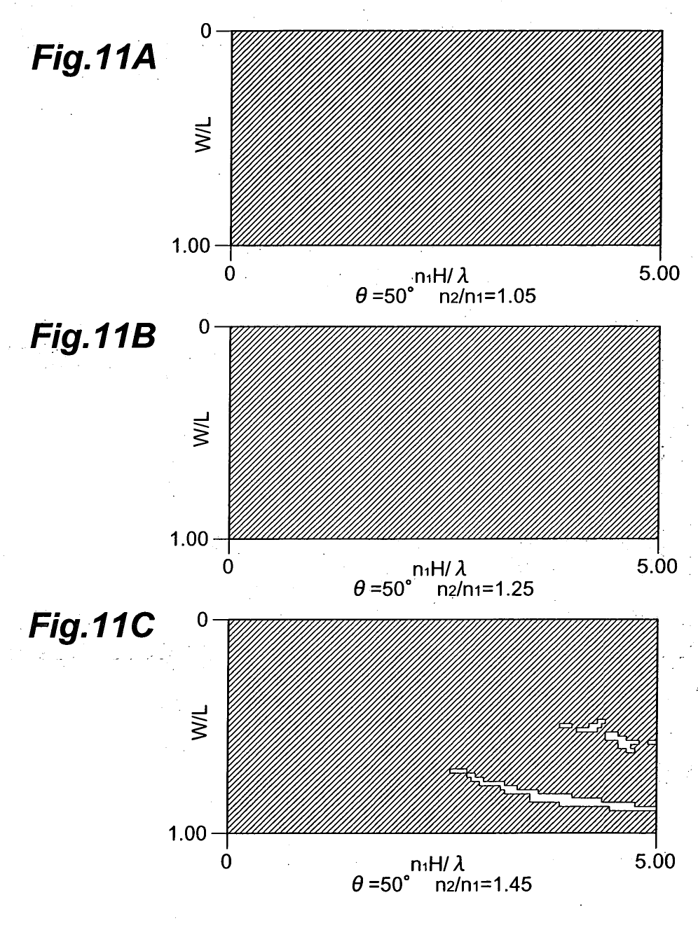

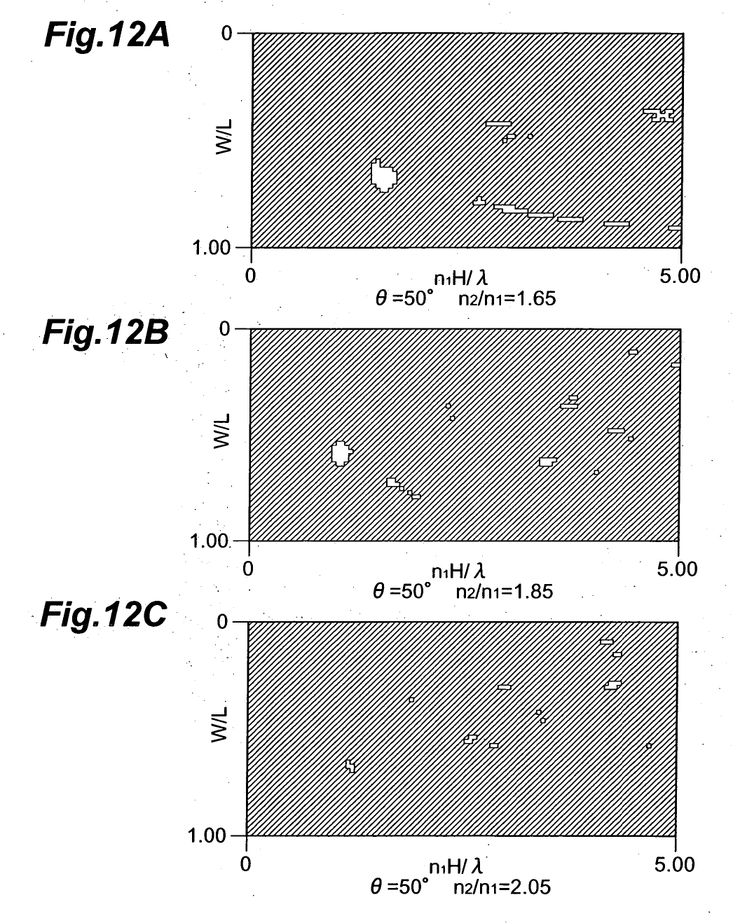

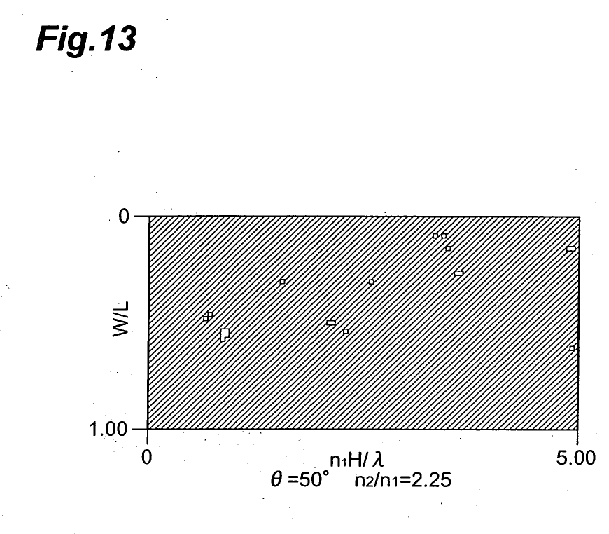

In simulation B, a condition that the difference between diffraction efficiencies η_{TE} and η_{TM} was 0.05 or less was added to the condition that min(η_{TE}, η_{TM})≧0.8, and combinations of parameters (n₂/n₁, n₁H/λ, W/L, and θ) satisfying both of the conditions were determined. Specifically, combinations of parameters in which both min(η_{TE}, η_{TM})≧0.8 and |η_{TE}−η_{TM}|≦0.05 were investigated within the same parameter range as in simulation A. Results thereof are partly shown in FIGS. 11A to 15C as contour maps of diffraction efficiency.

FIGS. 11A to 13 are contour maps of η_{TE} and η_{TM} in the case where n₂/n₁ was changed from 1.05 to 2.25 in increments of 0.20 while setting θ at 50°. The white parts in the maps indicate regions where both min(η_{TE}, η_{TM})≧0.8 and |η_{TE}−η_{TM}|≦0.05 are satisfied. On the other hand, the hatched parts in the maps indicate regions where the above-mentioned conditions (min(η_{TE}, η_{TM})≧0.8 and |η_{TE}31 η_{TM}|≦0.05) are not satisfied.

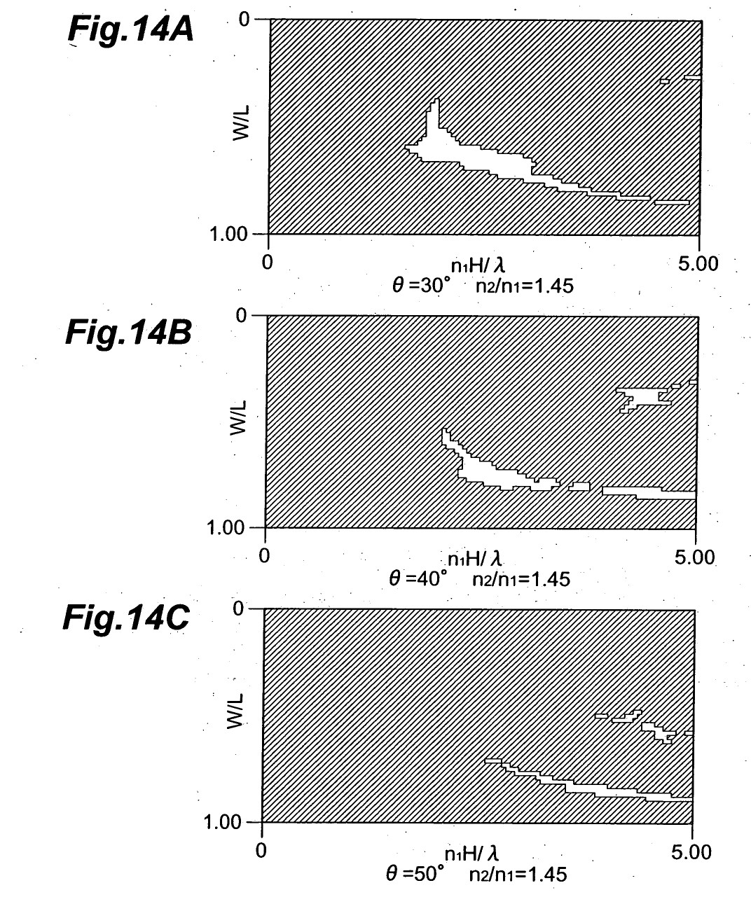

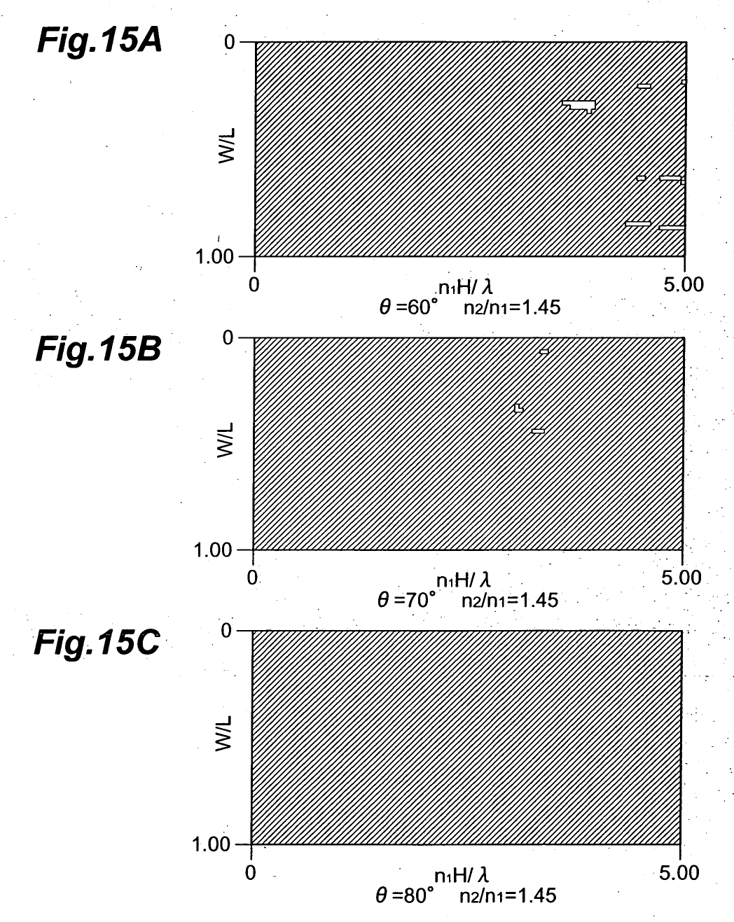

FIGS. 14A to 15C are contour maps of η_{TE} and η_{TM} in the case where θ was changed from 30° to 80° in increments of 10° while fixing n₂/n₁ at 1.45. The white parts in the maps indicate regions where the above-mentioned conditions (min(η_{TE}, η_{TM})≧0.8 and |η_{TE}−η_{TM}|≦0.05) are satisfied.

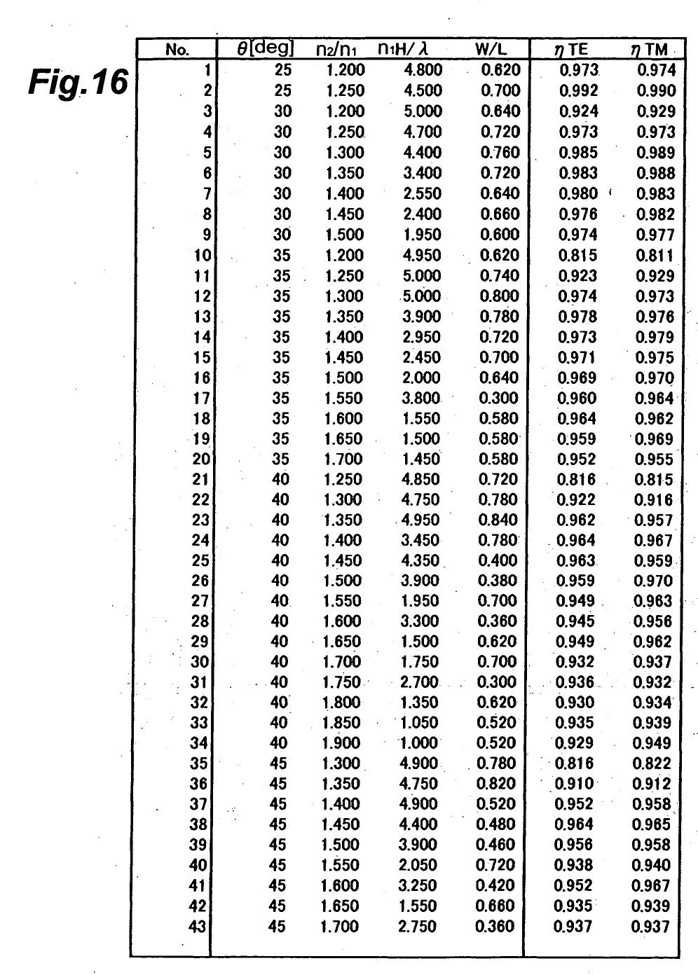

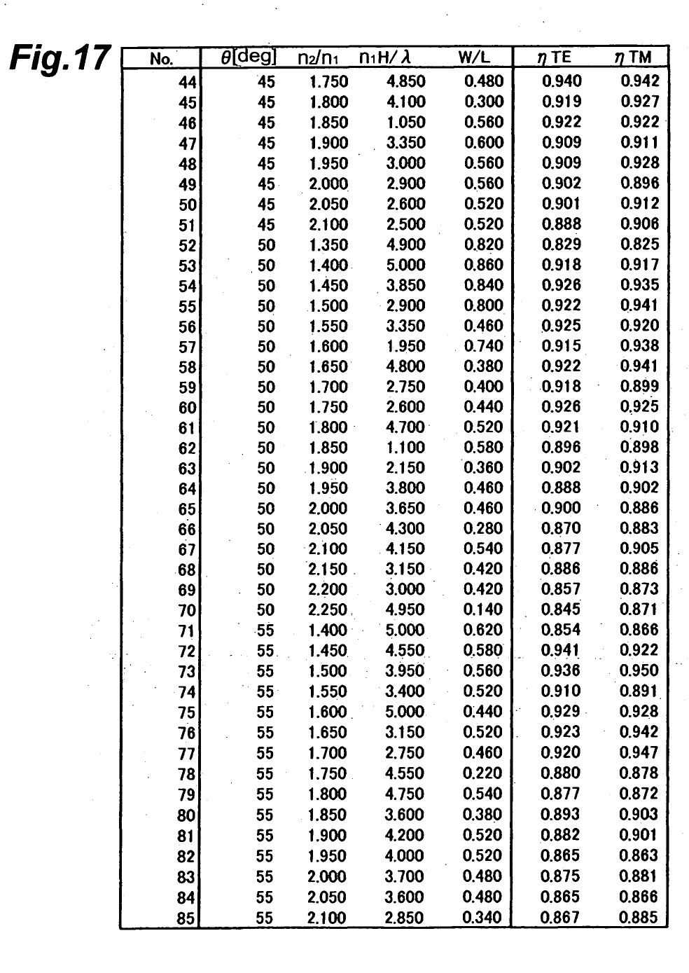

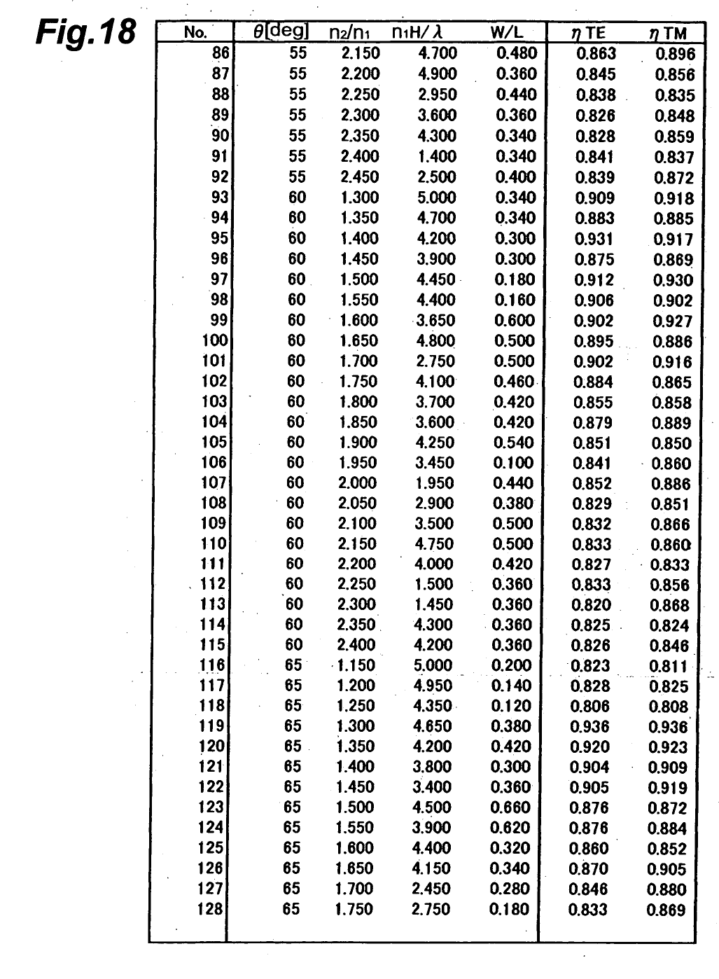

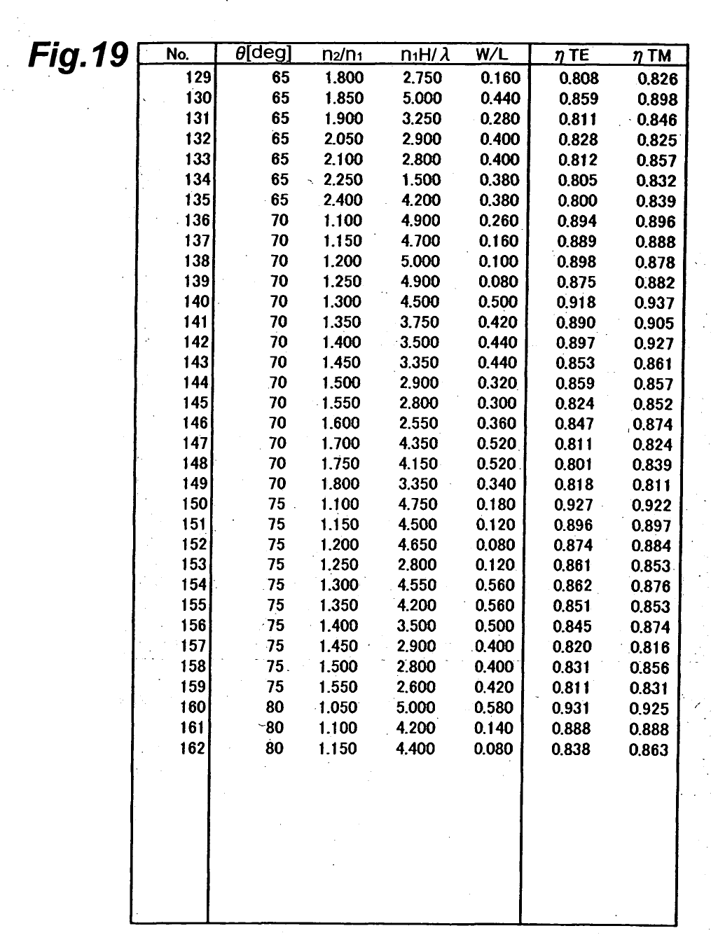

Regions satisfying the above-mentioned conditions (min(η_{TE}, η_{TM})≧0.8 and |η_{TE}−η_{TM}|≦0.05) also exist in combinations of parameters (n₂/n₁, n₁H/λ, W/L, and θ) other than those shown in FIGS. 11A to 15C under the condition satisfying both expressions (1) and (2). In these regions, FIGS. 16 to 19 show values of the parameters n₂/n₁, n₁H/λ, W/L, and θ when max(1−min (η_{TE}, η_{TM}), 4|η_{TE}−η_{TM}|) attains the smallest value, and values of η_{TE} and η_{TM} at that time.

Here, |η_{TE}−η_{TM}| is multiplied by a coefficient value of 4 in order to convert the value of |η_{TE}−η_{TM}| (0 to 0.05) into the same range as with the value of 1-min (η_{TE}, η_{TM}) (0 to 0.2), so that they can be compared with each other.

Thus, combinations of parameters in which each of the respective diffraction efficiencies in TE and TM polarization modes of the transmitted first-order diffracted light L3₁ became at least 0.8 whereas the difference between the diffraction efficiencies in these modes became 0.05 or less were found in simulation B.

When this transmitted type diffractive optical element 1 is used as a component (e.g., multiplexer or demultiplexer) of an optical communication system, for example, the polarization dependence of diffraction efficiency in the transmitted type diffractive optical element becomes smaller, whereby communication errors can be reduced in all the polarization states.

Simulation C

In simulation C, parameters (n₂/n₁, n₁H/λ, W/L, and θ) were changed as in simulation A. Further, assuming that the light L1 had a wavelength band of λ±0.016λ about the wavelength λ as the center wavelength, a simulation was carried out by using RCWA, so as to determine respective diffraction efficiencies η_{TE} and η_{TM} in TE and TM polarization modes of the transmitted first-order diffracted light L3₁.

Each of sets of η_{TE1} to η_{TE33} and η_{TM1} to η_{TM33} are 33 values obtained by changing the wavelength in increments of 0.001λ in the wavelength band (λ−0.016λ to λ+0.016λ). From these values (η_{TE1} to η_{TE33} and η_{TM1} to η_{TM33}), the maximum value ηₘₐₓ and minimum value ηₘᵢₙ were determined. Here, the minimum value ηₘᵢₙ is given by min (η_{TE1}, η_{TE2}, . . . , η_{TE33}, η_{TM1}, η_{TM2}, . . . , η_{TM33}), whereas the maximum value ηₘₐₓ is given by max (η_{TE1}, η_{TE2}, . . . , η_{TE33}, η_{TM1}, η_{TM2}, . . . , η_{TM33}).

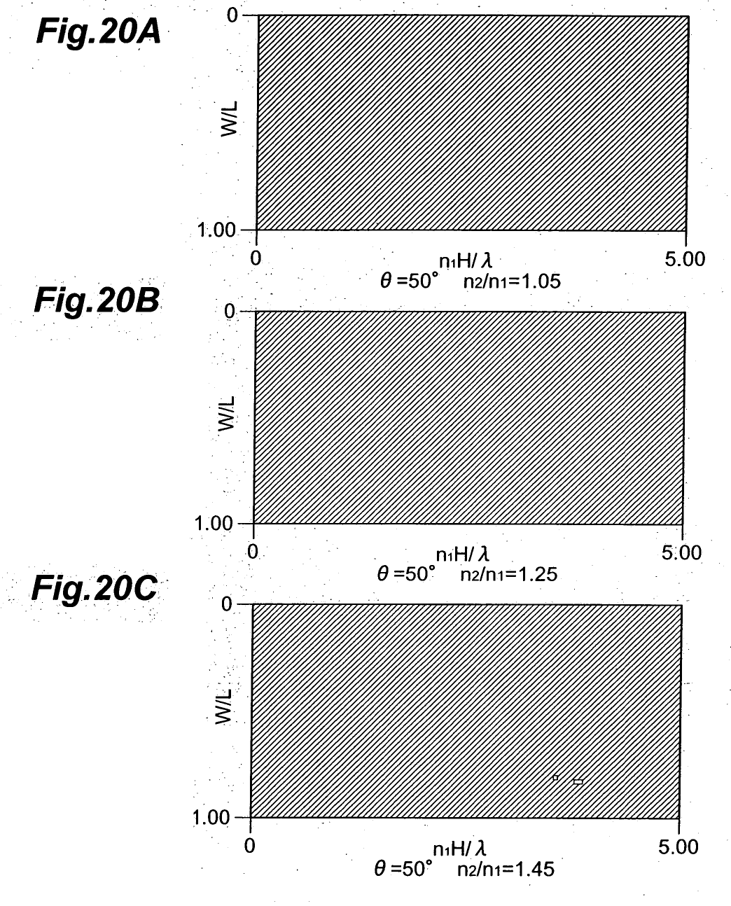

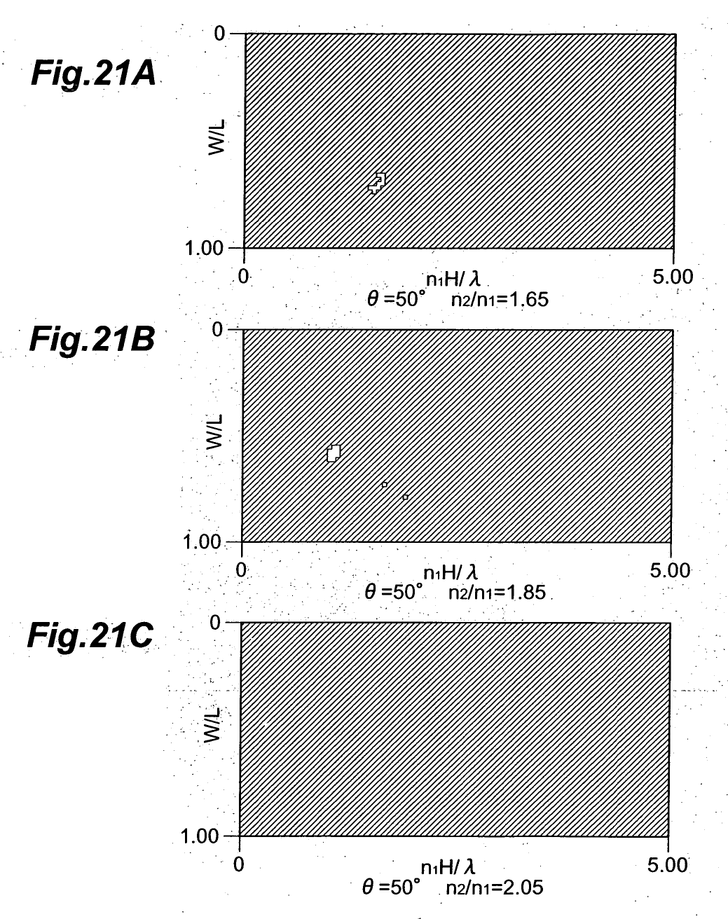

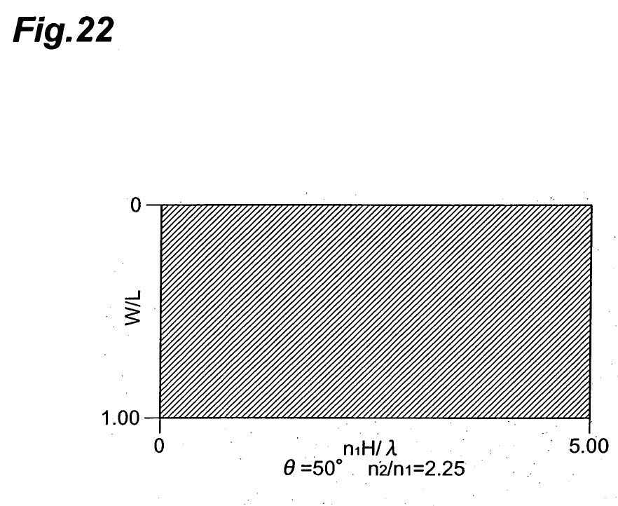

Further, within the range of parameters satisfying both expressions (1) and (2), combinations of parameters in which ηₘᵢₙ became at least 0.8 (ηₘᵢₙ≧0.8) while the difference between ηₘₐₓ and ηₘᵢₙ became 0.05 or less (|ηₘₐₓ−ηₘᵢₙ≦0.05) were investigated. Results thereof are partly shown by FIGS. 20A to 24C as contour maps of diffraction efficiency.

FIGS. 20A to 22 are contour maps of ηₘₐₓ and ηₘᵢₙ in the case where θ is fixed at 50°, the light L1 is assumed to have a wavelength band of λ±0.016λ about the wavelength λ as the center wavelength, and n₂/n₁ is changed from 1.05 to 2.25 in increments of 0.20. The white parts in the maps indicate regions in which both ηₘᵢₙ≧0.8 and |ηₘₐₓ−ηmin|≦0.05 are satisfied. On the other hand, the hatched parts in the maps indicate regions in which the above-mentioned conditions ηₘᵢₙ≧0.8 and |ηₘₐₓ−ηₘᵢₙ|≦0.05 are not satisfied.

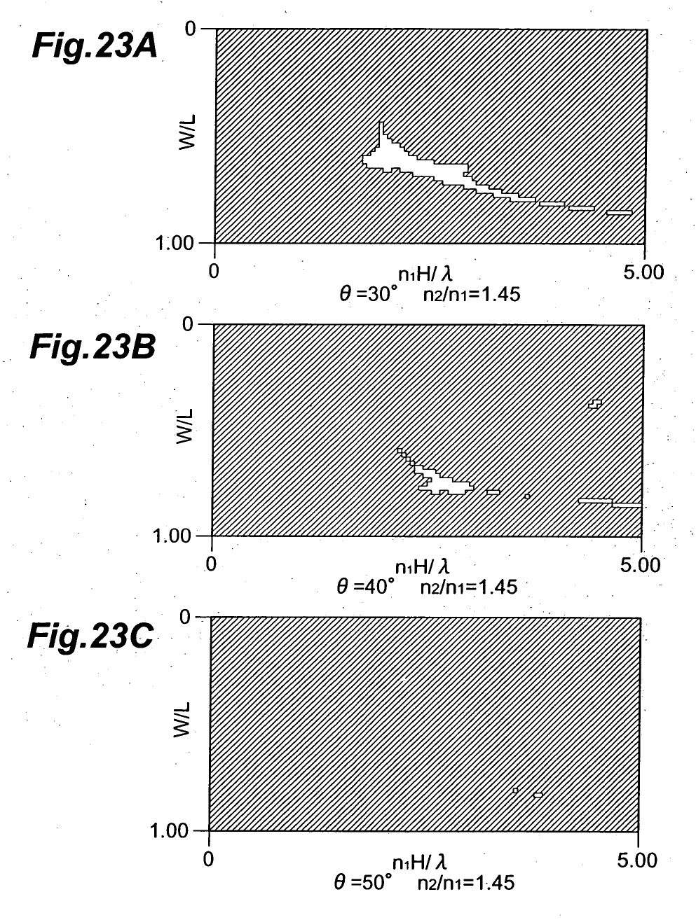

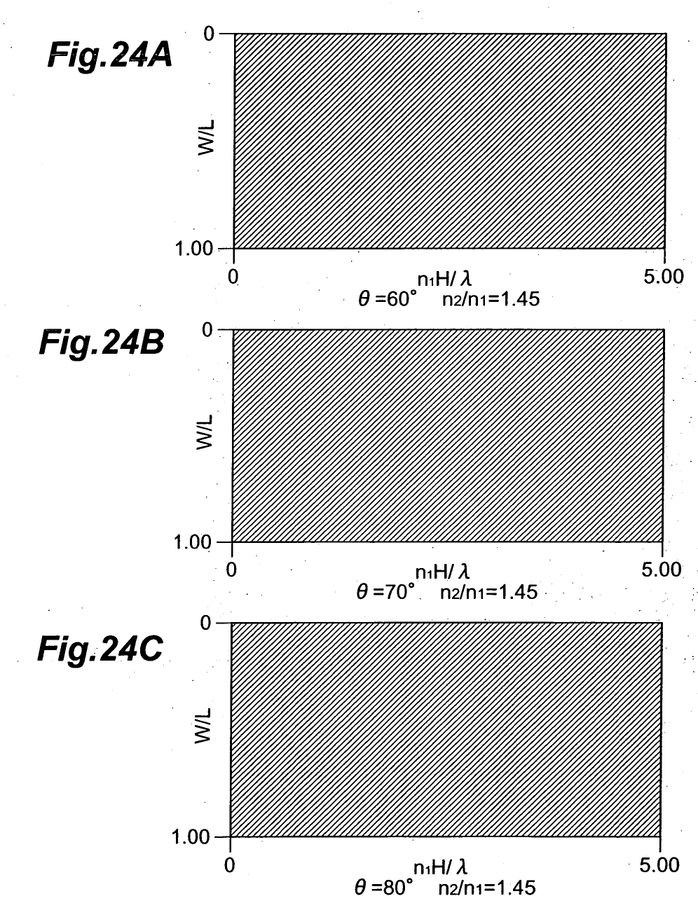

FIGS. 23A to 24C are contour maps of ηₘₐₓ and ηₘᵢₙ in the case where n₂/n₁ is fixed at 1.45, the light L1 is assumed to have a wavelength band of λ±0.016λ about the wavelength λ as the center wavelength, and θ is changed from 30° to 80° in increments of 10°. The white parts in the maps indicate regions in which the above-mentioned conditions (ηₘᵢₙ≦0.8 and |ηₘₐₓ−ηₘᵢₙ|≦0.05) are satisfied.

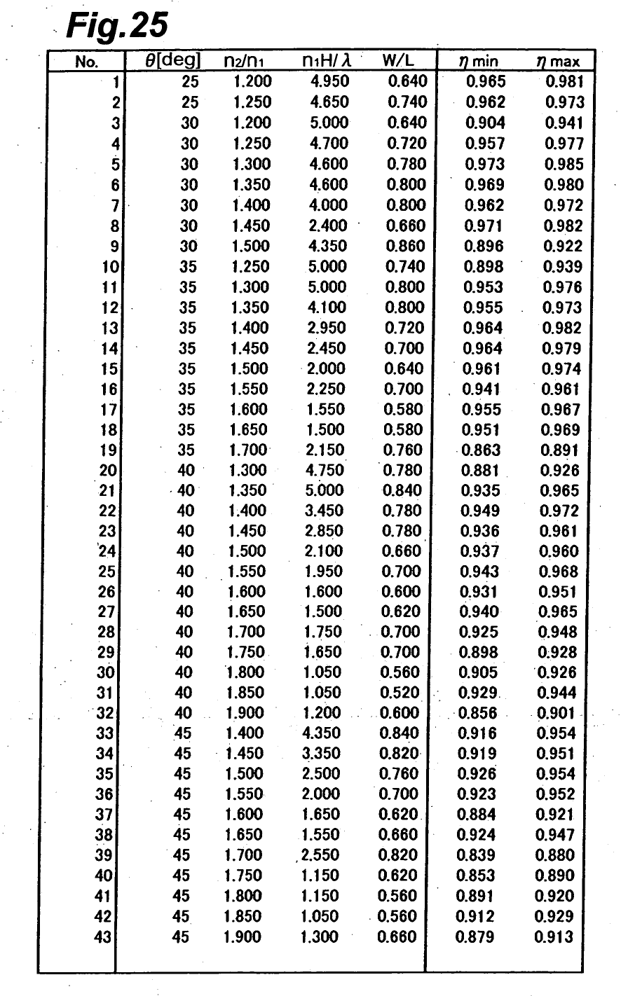

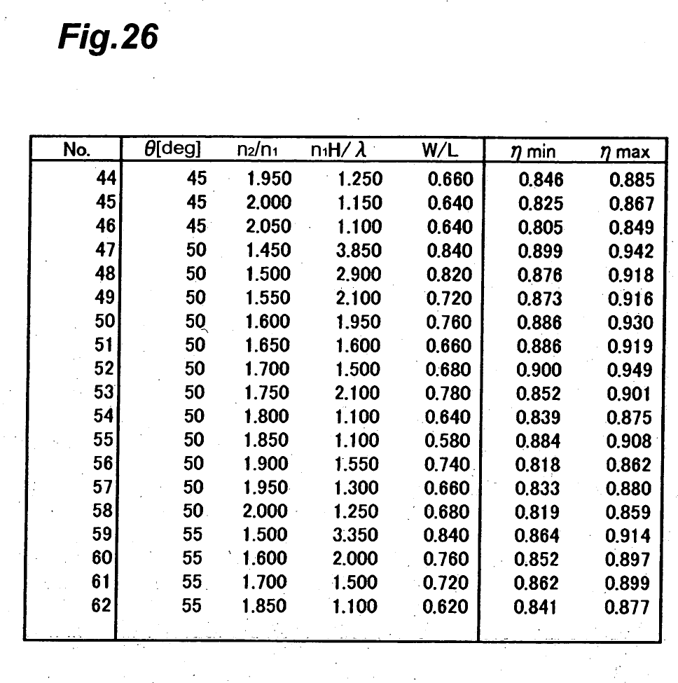

Regions satisfying the above-mentioned conditions (ηₘᵢₙ≧0.8 and |ηₘₐₓ−ηₘᵢₙ|≦0.05) also exist in combinations of parameters (n₂/n₁, n₁H/λ, W/L, and θ) other than those shown in FIGS. 20A to 24C under the condition satisfying both expressions (1) and (2). FIGS. 25 and 26 show values of parameters n₂/n₁, n₁H/λ, W/L, and θ when max(1−ηₘᵢₙ, 4|ηₘₐₓ−ηₘᵢₙ|) attains the smallest value in these regions, and values of ηₘᵢₙ and ηₘₐₓ at that time in these regions.

Here, |ηₘₐₓ−ηₘᵢₙ| is multiplied by a coefficient value of 4 in order to convert the value of |ηₘₐₓ−ηₘᵢₙ| (0 to 0.05) into the same range as with the value of 1−ηₘᵢₙ (0 to 0.2), so that they can be compared with each other.

Thus, within the range of wavelength band λ±0.016λ about the wavelength λ as the center wavelength, designing conditions of the transmitted type diffractive optical element 1 (combinations of parameters) in which each of the diffraction efficiencies in TE and TM polarization modes became at least 0.8 while the difference between the maximum and minimum values of diffraction efficiencies in TE and TM polarization modes became 0.05 or less was found in simulation C.

Table 2 shows the total diffraction efficiency at the wavelength λ in each of No. 8 (FIG. 25) and No. 55 (FIG. 26).

TABLE 2

| | | Diffraction efficiency | | | | |
|---|---|---|---|---|---|---|
| | | | | trans- | trans- | |
| | Polari- | reflected | reflected | mitted | mitted | |
| | zation | 0-order | 1st-order | 0-order | 1st-order | total |
| No. 8 | TE | 0.016 | 0.007 | 0.001 | 0.976 | 1.000 |
| | TM | 0.012 | 0.006 | 0.000 | 0.982 | 1.000 |
| No. 55 | TE | 0.065 | 0.027 | 0.012 | 0.896 | 1.000 |
| | TM | 0.002 | 0.052 | 0.048 | 0.898 | 1.000 |

As shown in Table 2, the transmitted type diffractive optical element 1 in accordance with this embodiment sets parameters (θ, n₂/n₁, and n₁L/λ) so as to satisfy both expressions (1) and (2), whereby no higher-order diffracted light is generated other than reflected zero-order diffracted light, reflected first-order diffracted light, transmitted zero-order diffracted light L3₀, and transmitted first-order diffracted light L3_{1.}

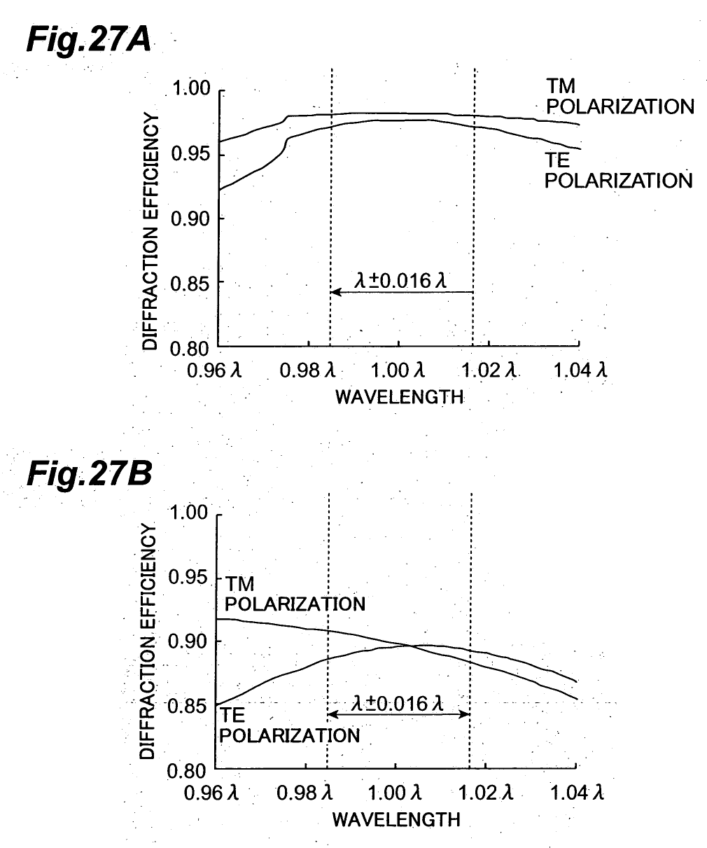

FIG. 27A shows the relationship between η_{TE} and wavelength and the relationship between η_{TM} and wavelength in No. 8 (FIG. 25). The ordinate and abscissa of the chart show the diffraction efficiency and the wavelength of light L1, respectively. In this chart, the wavelength is changed within the range of ±4%, so as to determine the diffraction efficiency. The range defined by broken lines is the range of wavelength band λ±0.016λ about the wavelength λ as the center wavelength. Within this range (λ−0.016λ to λ+0.016λ), each of η_{TE} and η_{TM} is at least 0.8 whereas the difference between ηₘₐₓ and ηₘᵢₙ is 0.05 or less.

FIG. 27B shows the relationship between η_{TE} and wavelength and the relationship between η_{TM} and wavelength in No. 55 (FIG. 26). Within the range of wavelength band λ±0.016λ about the wavelength λ as the center wavelength, each of η_{TE} and η_{TM} is at least 0.8 whereas the difference between ηₘₐₓ and ηₘᵢₙ is 0.05 or less.

When this transmitted type diffractive optical element 1 is incorporated in an optical communication system, the diffraction efficiency, i.e., the polarization dependence and wavelength dependence of optical loss, in the transmitted type diffractive optical element 1 becomes smaller, whereby communication errors can be reduced with respect to all the polarizations and wavelengths within the wavelength band.

Also, using this transmitted type diffractive optical element 1 can cover the whole region of C band (having a wavelength of 1.53 to 1.565 μm) and 85% of L band (having a wavelength of 1.565 to 1.625 μm) which are wavelength bands defined by an international standard (ITU).

Simulation C was carried out while setting the band to λ±0.016λ, which is an example of methods of designing a diffraction grating with respect to light having a wavelength band. The band is set to 1.53 to 1.565 μm when using the diffraction grating in C band, 1.565 to 1.625 μm when using the diffraction grating in L band, and 1.53 to 1.625 μm when using the diffraction grating in both C and L bands, while designing is carried out by a technique similar to simulation C.

Simulation D

In simulation D, while changing parameters (n₂/n₁, n₁H/λ, W/L, and θ) as in simulation A, combinations of parameters in which each of respective diffraction efficiencies η_{TE} and η_{TM} in TE and TM polarization modes of transmitted first-order diffracted light L3₁ became at least 0.85 or at least 0.90 under the condition satisfying both expressions (1) and (2) were investigated.

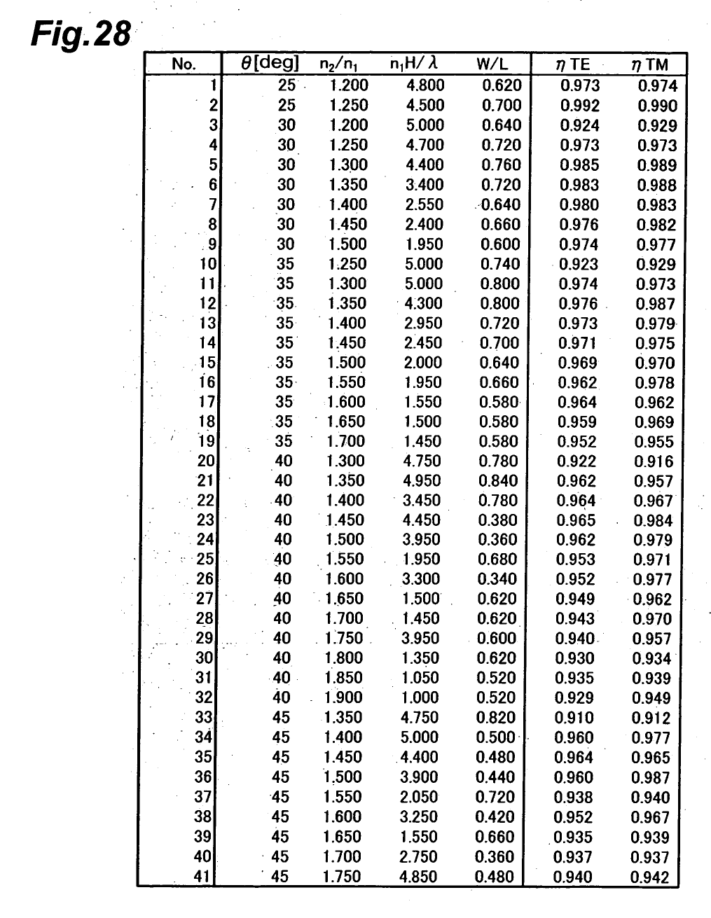

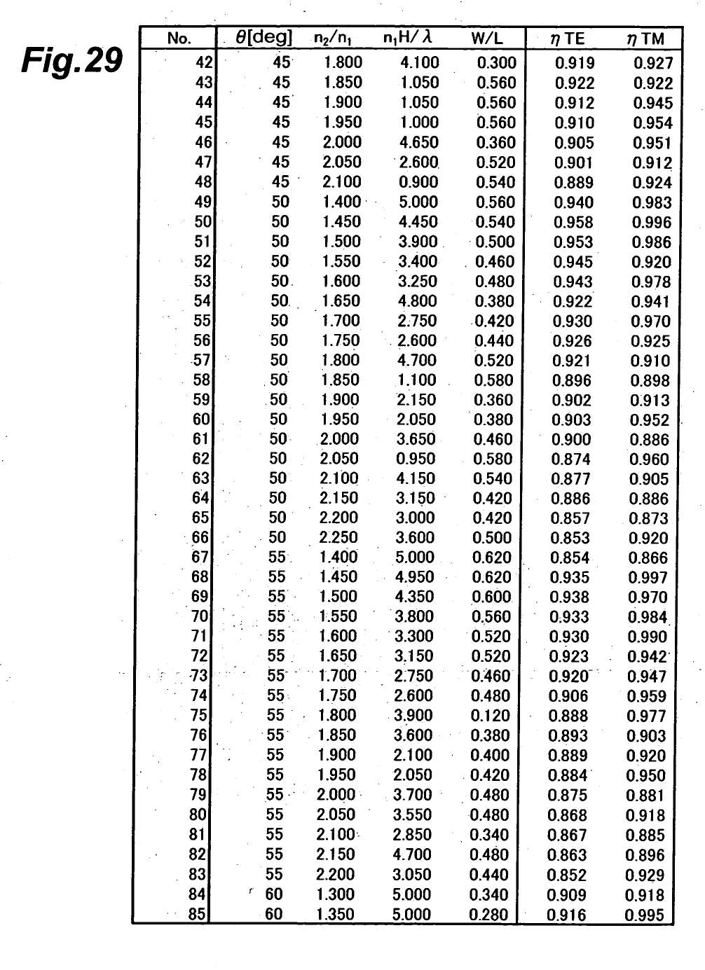

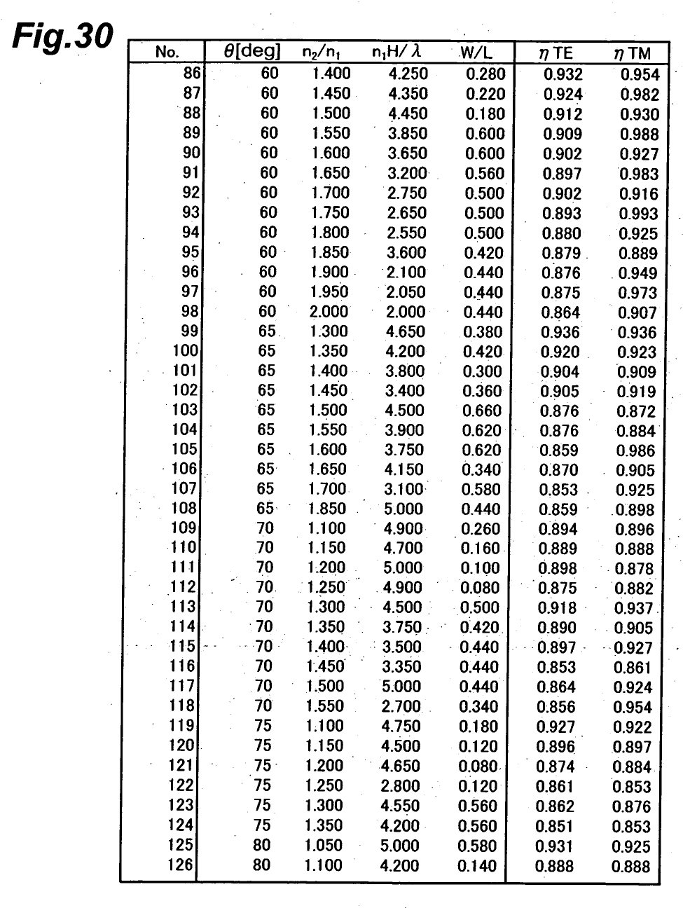

FIGS. 28 to 30 show values of parameters n₂/n₁, n₁H/λ, W/L, and θ obtained when each of η_{TE} and η_{TM} is at least 0.85 while min(η_{TE}, η_{TM}) attains the highest value, and values of η_{TE} and η_{TM} at that time.

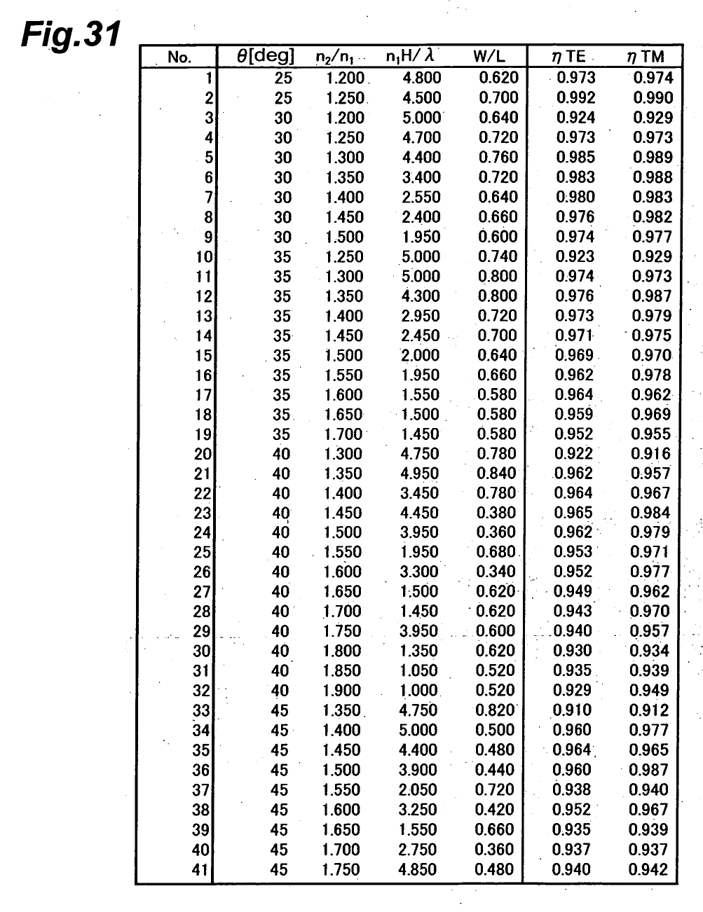

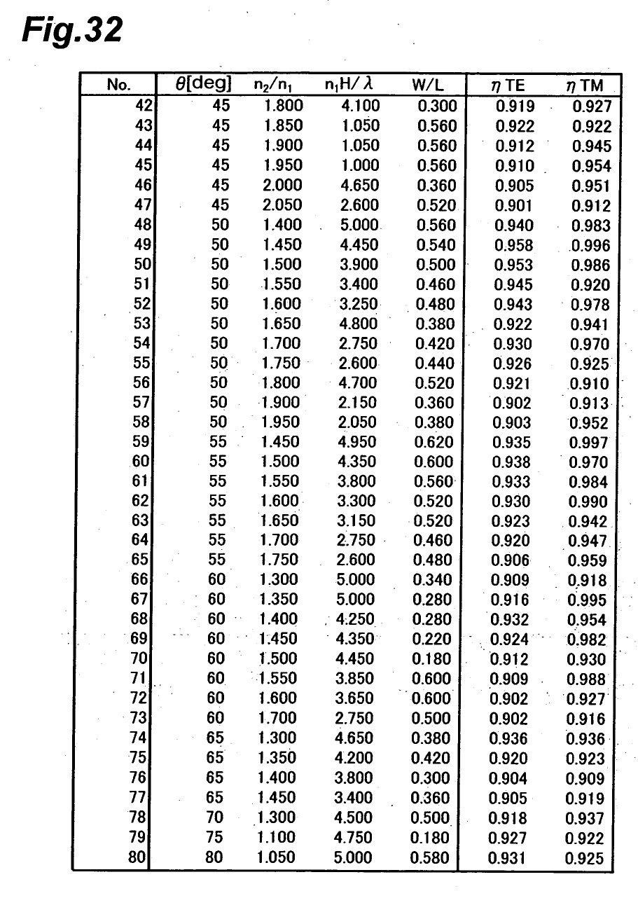

FIGS. 31 and 32 show values of parameters n₂/n₁, n₁H/λ, W/L, and θ obtained when each of η_{TE} and η_{TM} is at least 0.90 while min (η_{TE}, η_{TM}) attains the highest value, and values of η_{TE} and η_{TM} at that time.

Here, as mentioned above, FIGS. 7 to 10 show values of parameters n₂/n₁, n₁H/λ, W/L, and θ obtained when each of η_{TE} and η_{TM} is at least 0.80 while min (η_{TE}, η_{TM}) attains the highest value, and values of η_{TE} and η_{TM} at that time.

Thus, combinations of parameters in which each of the diffraction efficiencies η_{TE} and η_{TM} in TE and TM polarization modes of transmitted first-order diffracted light L3₁ became at least 0.85 or at least 0.90 were found in simulation D.

Simulation E

In simulation E, in a manner substantially the same as simulation B, parameters (n₂/n₁, n₁H/λ, W/L, and θ) were changed as in simulation A, a condition in which the difference between η_{TE} and η_{TM} became y or less was added to the condition that min (η_{TE}, η_{TM})≧x, and combinations of parameters (n₂/n₁, n₁H/λ, W/L, and θ) satisfying both of the conditions were determined. Specifically, combinations of parameters in which min (η_{TE}, η_{TM})≧x while |η_{TE}−η_{TM}|≦y were investigated within the same parameter range as in simulation A. Here, x is 0. 85 or 0.90, whereas y is 0.05 or 0.025.

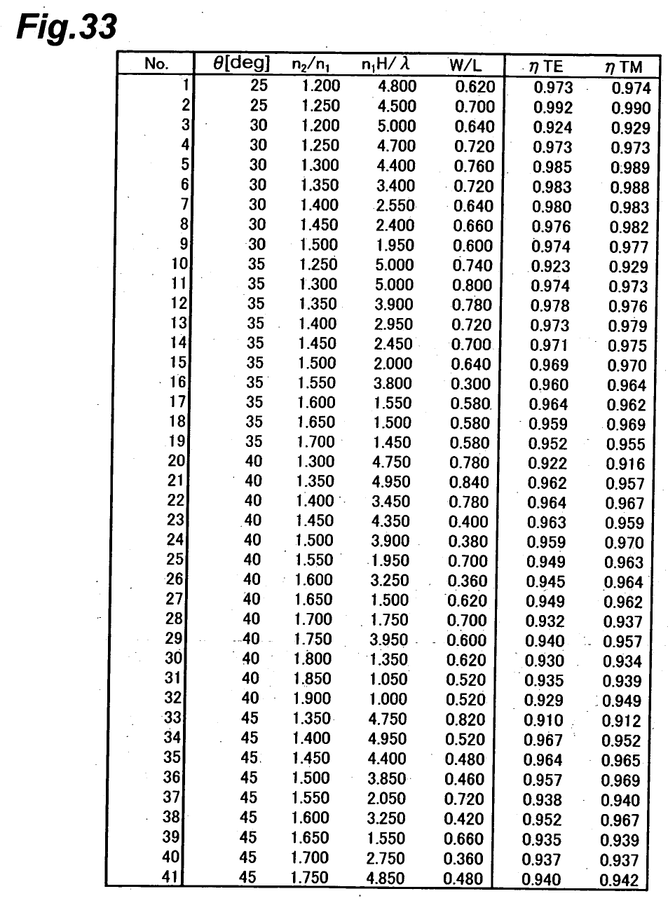

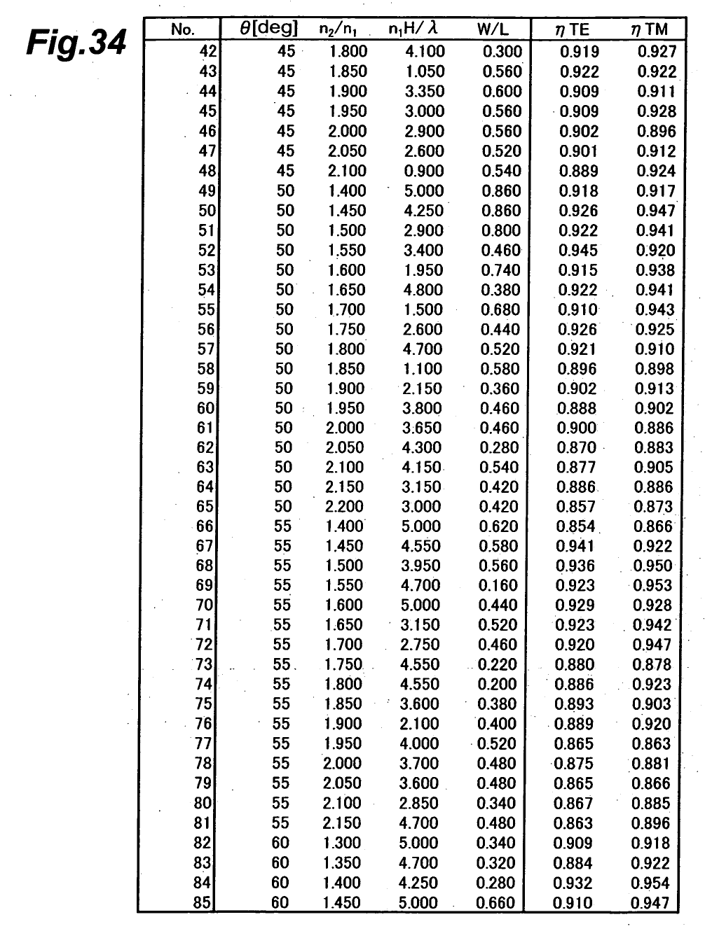

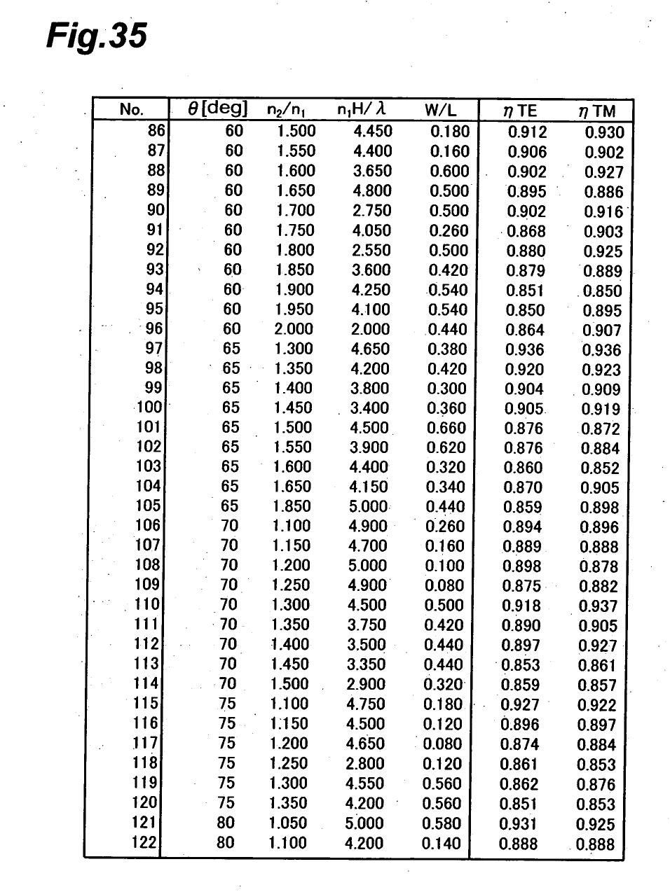

In the region satisfying the condition that min (η_{TE}, η_{TM})≧0.85 while |η_{TE}−η_{TM}|≦0.05, FIGS. 33 to 35 show values of parameters n₂/n₁, n₁H/λ, W/L, and θ obtained when max (1−min(η_{TE}, η_{TM}), 3|η_{TE}−η_{TM}|) attains the smallest value, and values of η_{TE} and η_{TM} at that time. Here, |η_{TE}−η_{TM}| is multiplied by a coefficient value of 3 in order to convert the value of |η_{TE}−η_{TM}| (0 to 0.05) into the same range as with the value of 1−min (η_{TE}, η_{TM}) (0 to 0.15), so that they can be compared with each other.

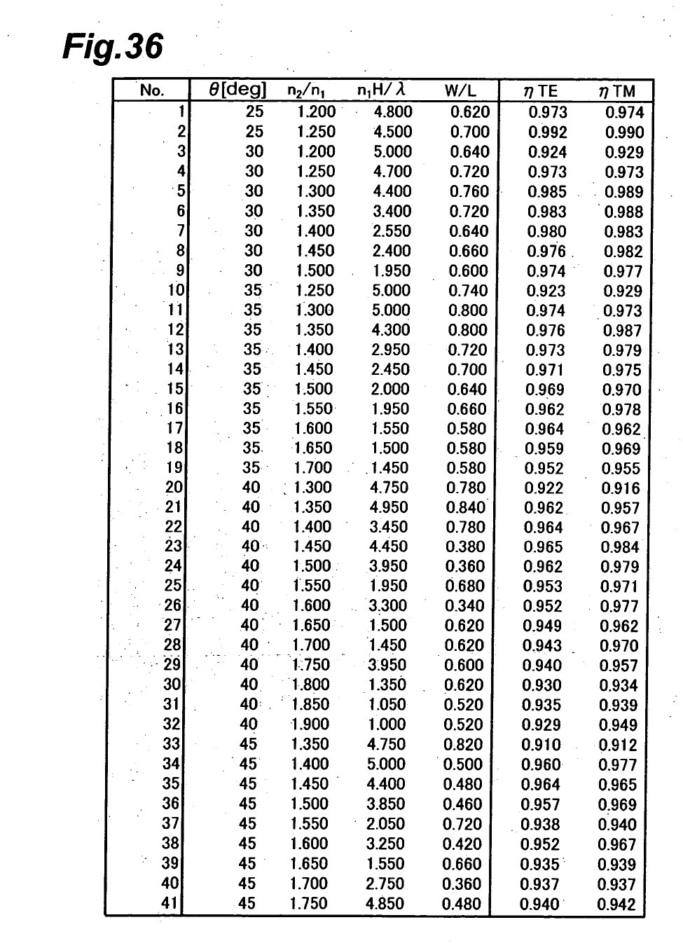

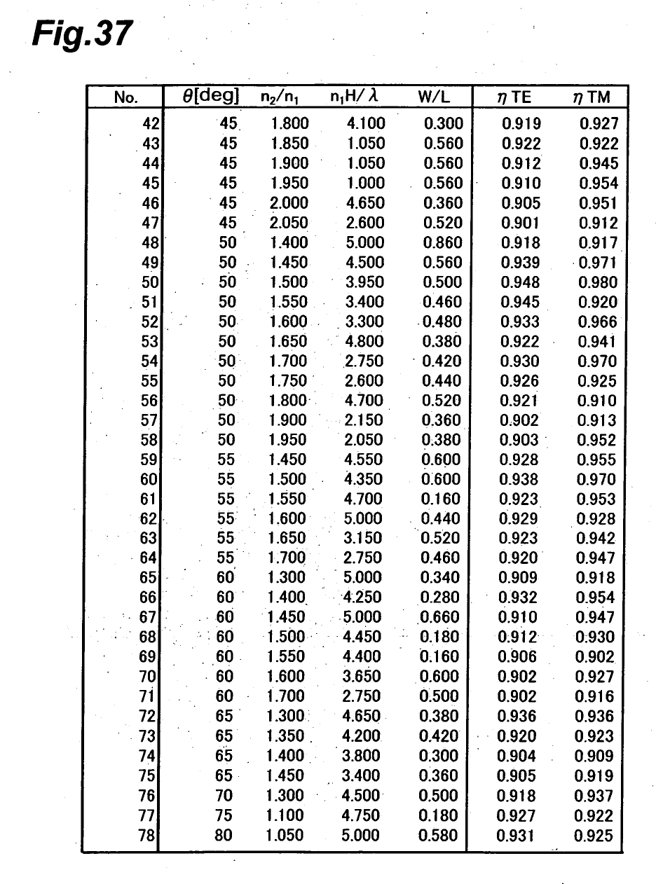

In the region satisfying the condition that min(η_{TE}, η_{TM})≧0.90 while |η_{TE}|η_{TM}|≦0.05, FIGS. 36 and 37 show values of parameters n₂/n₁, n₁H/λ, W/L, and θ obtained when max (1−min(η_{TE}, η_{TM}), 2|η_{TE}−η_{TM}|) attains the smallest value, and values of η_{TE} and η_{TM} at that time. Here, |η_{TE}−η_{TM}| is multiplied by a coefficient value of 2 in order to convert the value of |η_{TE}−η_{TM}| (0 to 0.05) into the same range as with the value of 1−min(η_{TE}, η_{TM}) (0 to 0.1), so that they can be compared with each other.

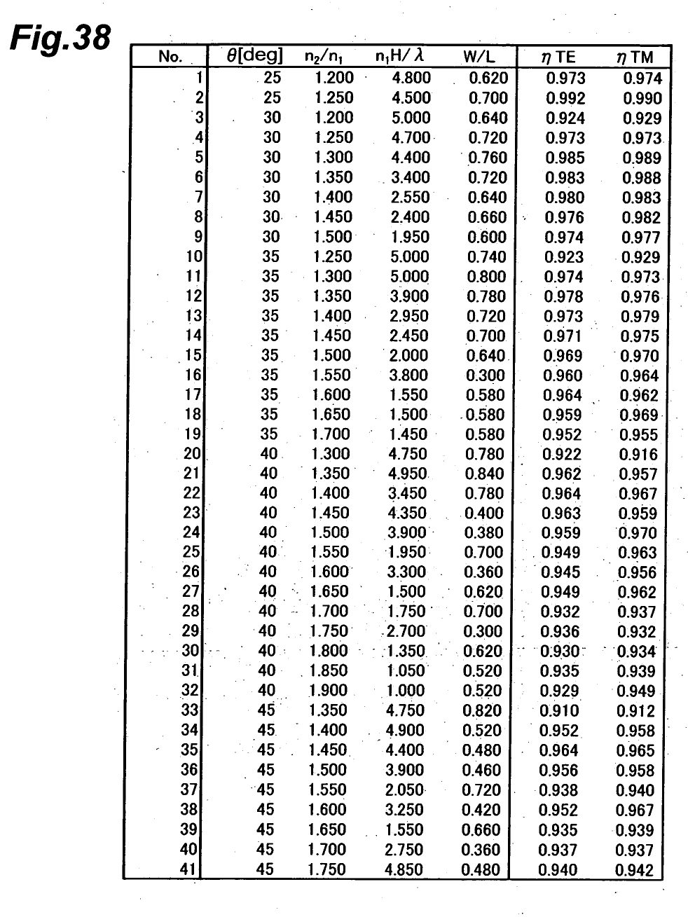

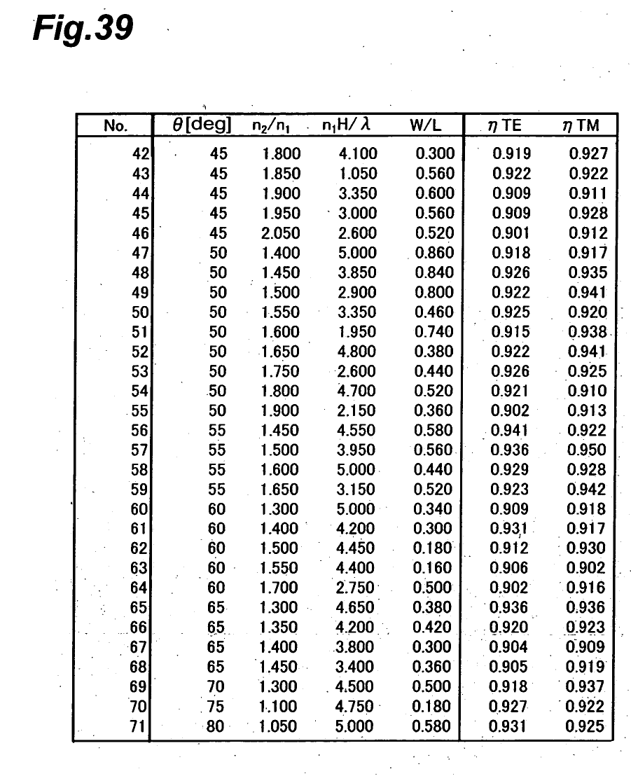

In the region satisfying the condition that min (η_{TE}, η_{TM})≧0.90 while |η_{TE}−η_{TM}|≦0.025, FIGS. 38 and 39 show values of parameters n₂/n₁, n₁H/λ, W/L, and θ obtained when max(1−min(η_{TE}, η_{TM}), 4|η_{TE}−η_{TM}|) attains the smallest value, and values of η_{TE} and η_{TM} at that time. Here, |η_{TE}−η_{TM}| is multiplied by a coefficient value of 4 in order to convert the value of |η_{TE}−η_{TM}| (0 to 0.025) into the same range as with the value of 1−min (η_{TE}, η_{TM}) (0 to 0.10), so that they can be compared with each other.

In the region satisfying the condition that min(η_{TE}, η_{TM})≧0.80 while |η_{TE}−η_{TM}|≦0.05, FIGS. 16 to 19 show values of parameters n₂/n₁, n₁H/λ, W/L, and θ obtained when max(1−min(η_{TE}, η_{TM}), 4|η_{TE}−η_{TM}|) attains the smallest value, and values of η_{TE} and η_{TM} at that time as mentioned above.

Thus, combinations of parameters in which each of respective diffraction efficiencies in TE and TM polarization modes of transmitted first-order diffracted light L3₁ became at least 0.85 or at least 0.90 while the difference in diffraction efficiency between these modes is not greater than 0.05 or not greater than 0.025 were found in simulation E.

Simulation F

In simulation F, in a manner substantially the same as simulation C, parameters (n₂/n₁, n₁H/λ, W/L, and θ) were changed as in simulation A, the light L1 is assumed to have a wavelength band of λ±0.016λ about the wavelength λ as the center wavelength, and a simulation was carried out by using RCWA, whereby respective diffraction efficiencies η_{TE} and η_{TM} in TE and TM polarization modes of transmitted first-order diffracted light L3₁ were determined.

Each of sets of η_{TE1} to η_{TE33} and η_{TM1} to η_{TM33} are 33 values obtained by changing the wavelength in increments of 0.001λ in the wavelength band (λ−0.016λto λ+0.016λ). From these values (η_{TE1} to η_{TE33} and η_{TM1} to η_{TM33}), the maximum value ηₘₐₓ and minimum value ηₘᵢₙ were determined. Here, the minimum value ηₘᵢₙ is given by min(η_{TE1}, η_{TE2}, . . . , η_{TE33}, η_{TM1}, η_{TM2}, . . . , η_{TM33}), whereas the maximum value ηₘₐₓ is given by max(η_{TE1}, η_{TE2}, . . . , η_{TE33}, η_{TM1}, η_{TM2}, . . . , η_{TM33}).

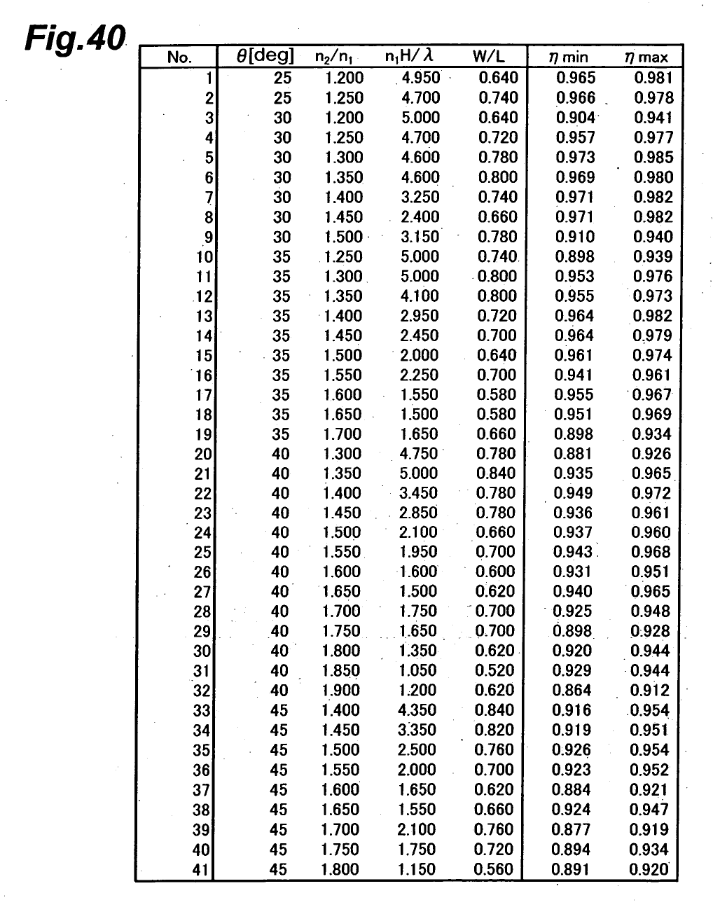

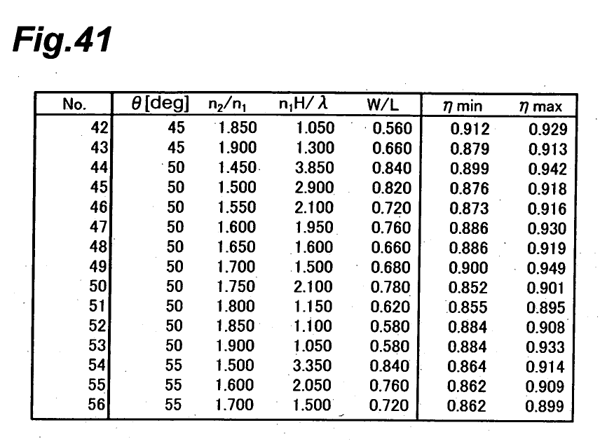

In the region satisfying the condition that ηₘᵢₙ≧0.85 while |ηₘₐₓ−ηₘᵢₙ|≦0.05, FIGS. 40 and 41 show values of parameters n₂/n₁, n₁H/λ, W/L, and θ obtained when max(1−ηₘᵢₙ, 3|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 3 in order to convert the value of |ηₘₐₓ−ηₘᵢₙ| (0 to 0.05) into the same range as with the value of 1−ηₘᵢₙ (0 to 0.15), so that they can be compared with each other.

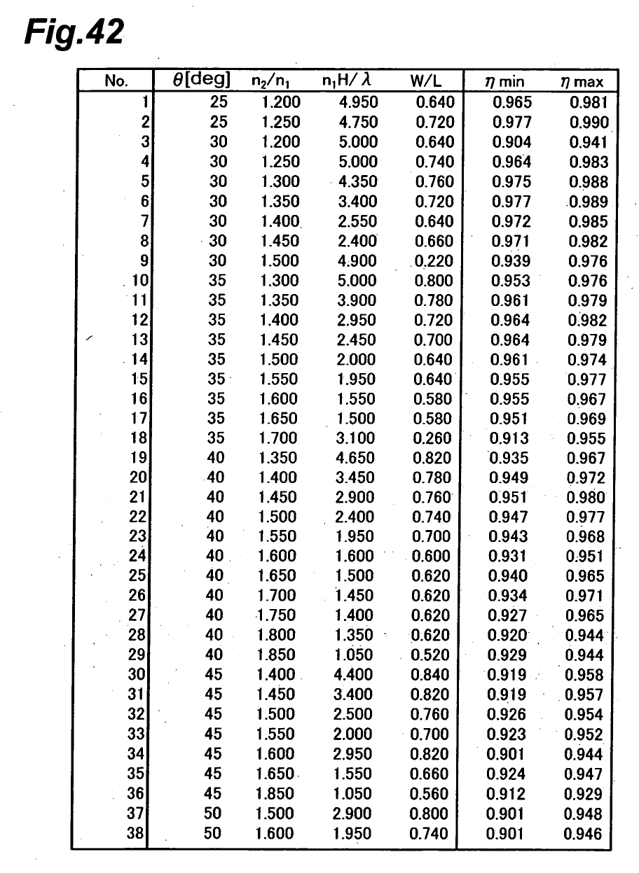

In the region satisfying the condition that ηₘᵢₙ≧0.90 while |ηₘₐₓ−ηₘᵢₙ≦0.05, FIG. 42 shows values of parameters n₂/n₁, n₁H/λ, W/L, and θ obtained when max(1−ηₘᵢₙ, 2|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 2 in order to convert the value of |ηₘₐₓ−ηₘᵢₙ| (0 to 0.05) into the same range as with the value of 1−ηₘᵢₙ (0 to 0.10), so that they can be compared with each other.

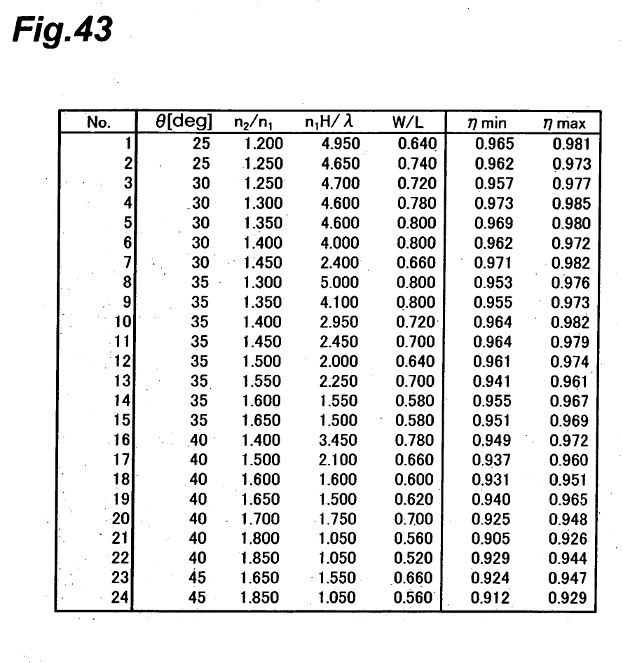

In the region satisfying the condition that ηₘᵢₙ≧0.90 while |ηₘₐₓ−ηₘᵢₙ|≦0.025, FIG. 43 shows values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 4 in order to convert the value of |ηₘₐₓ−ηₘᵢₙ| (0 to 0.025) into the same range as with the value of 1−ηₘᵢₙ (0 to 0.10), so that they can be compared with each other.

In the region satisfying the condition that ηₘᵢₙ≧0.80 while |ηₘₐₓ−ηₘᵢₙ|≦0.05, FIGS. 25 and 26 show values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time as mentioned above.

Thus, within the range of wavelength band λ±0.016λ about the wavelength λ as the center wavelength, designing conditions of the transmitted type diffractive optical element 1 (combinations of parameters) in which each of respective diffraction efficiencies in TE and TM polarization modes became at least 0.85 or at least 0.90 while the difference between the maximum and minimum values of diffraction efficiencies in TE and TM polarization modes was not greater than 0.05 or not greater than 0.025 were found in simulation F.

Simulation G

In simulation G, in a manner substantially the same as simulation C, parameters (n₂/n₁, n₁H/λ, W/L, and θ) were changed as in simulation A, the light L1 is assumed to have a bandwidth in C band, and a simulation was carried out by using RCWA, whereby respective diffraction efficiencies η_{TE} and η_{TM} in TE and TM polarization modes of transmitted first-order diffracted light L3₁ were determined. Also, the maximum value ηₘₐₓ and minimum value ηₘᵢₙ of η_{TE} and η_{TM} in C band were determined.

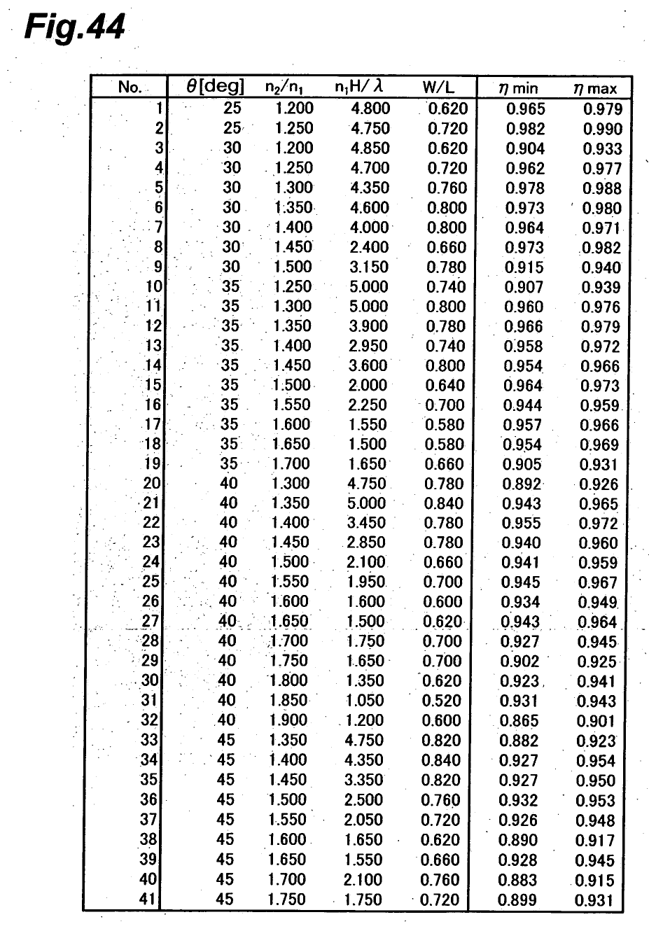

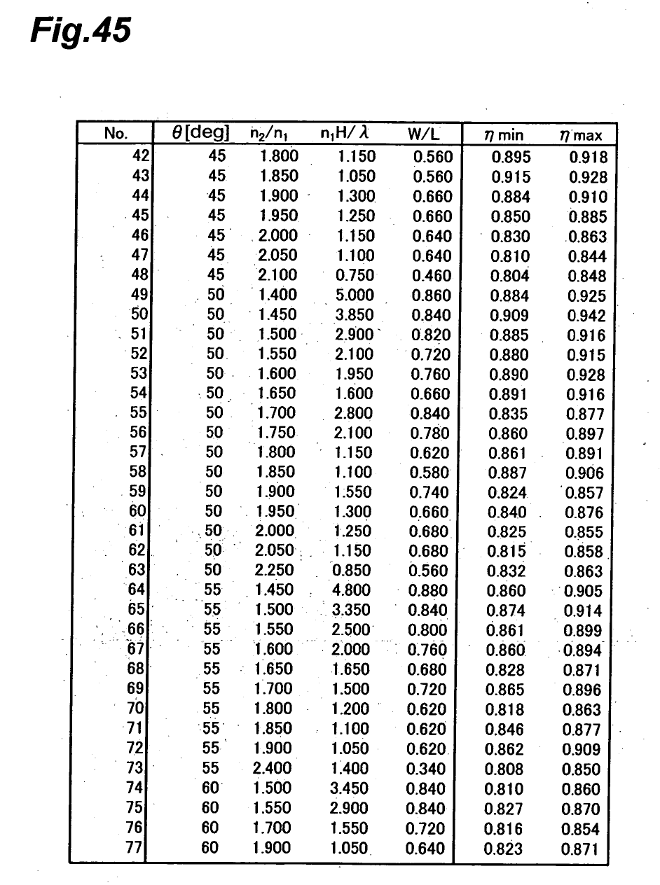

In the region satisfying the condition that ηₘᵢₙ≧0.80 while |ηₘₐₓ−ηₘᵢₙ|≦0.05, FIGS. 44 and 45 show values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 4 in order to convert the value of |ηₘₐₓ−ηₘᵢₙ| (0 to 0.05) into the same range as with the value of 1−ηₘᵢₙ (0 to 0.20), so that they can be compared with each other.

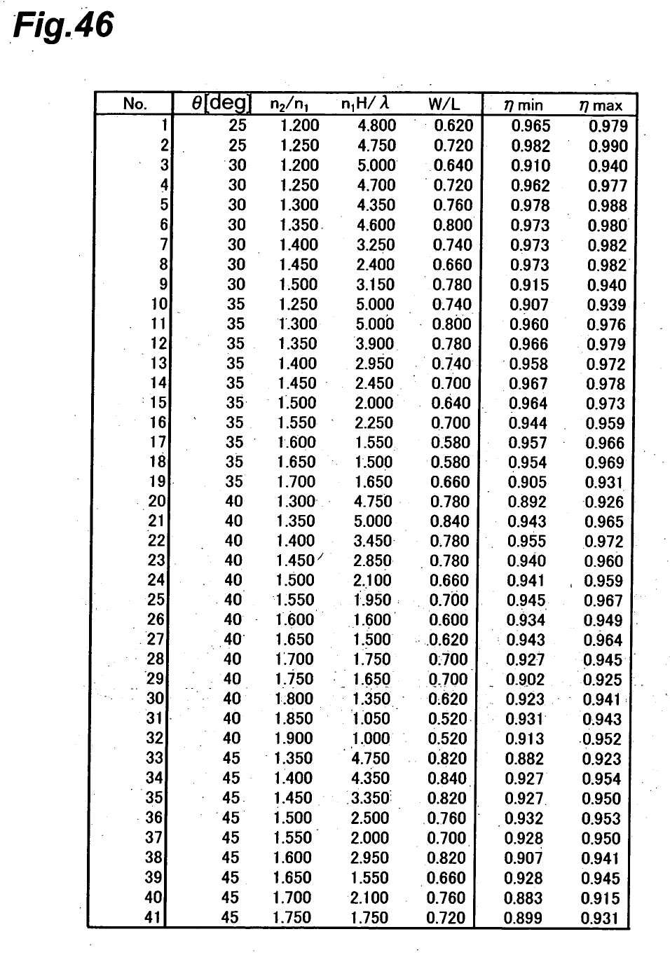

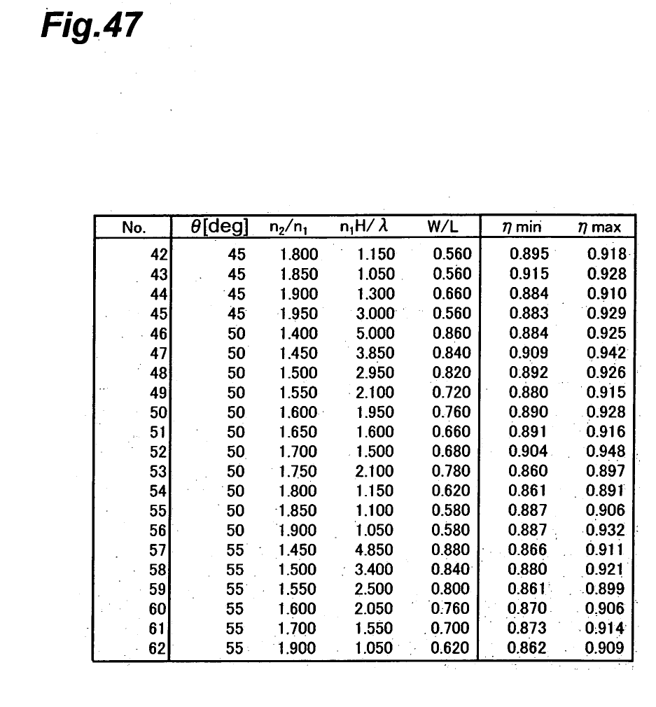

In the region satisfying the condition that ηₘᵢₙ≧0.85 while |ηₘₐₓ−ηₘᵢₙ|≦0.05, FIGS. 46 and 47 show values of parameters n₂/n₁, n₁H/λ, W/L, and θ obtained when max(1−ηₘᵢₙ, 3|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 3 in order to convert the value of |ηₘₐₓ−ηₘᵢₙ| (0 to 0.05) into the same range as with the value of 1−ηₘᵢₙ (0 to 0.15), so that they can be compared with each other.

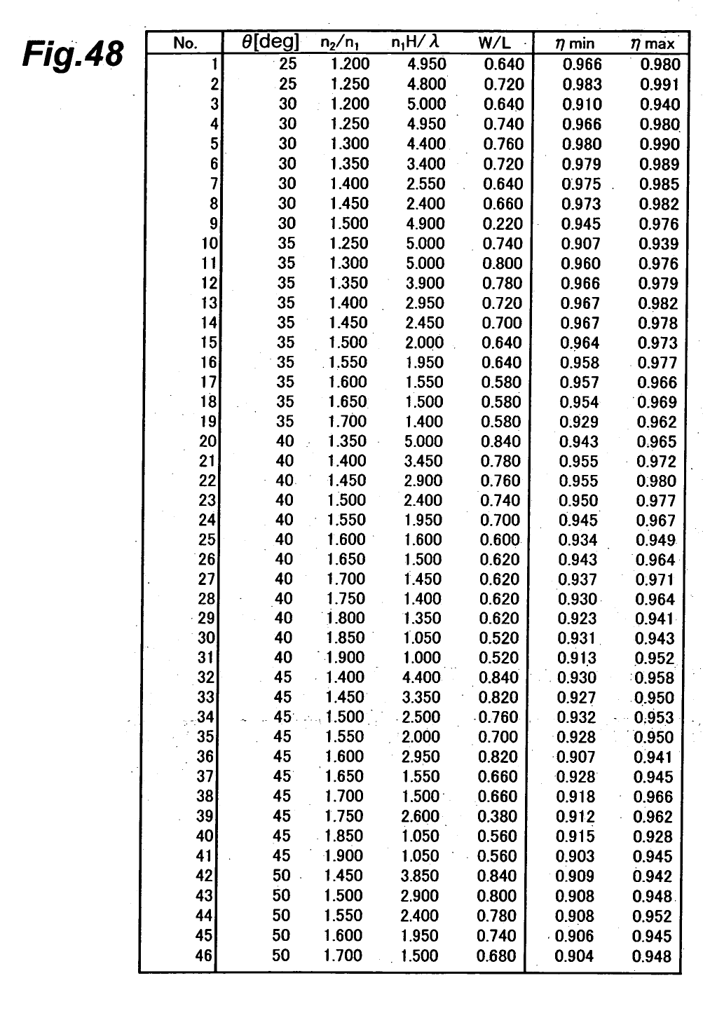

In the region satisfying the condition that ηₘᵢₙ≧0.90 while |ηₘₐₓ−ηₘᵢₙ|≦0.05, FIG. 48 shows values of parameters n₂/n₁, n₁H/λ, W/L, and θ obtained when max(1−θₘᵢₙ, 2|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 2 in order to convert the value of |ηₘₐₓ−ηₘᵢₙ| (0 to 0.05) into the same range as with the value of 1−ηₘᵢₙ (0 to 0.10), so that they can be compared with each other.

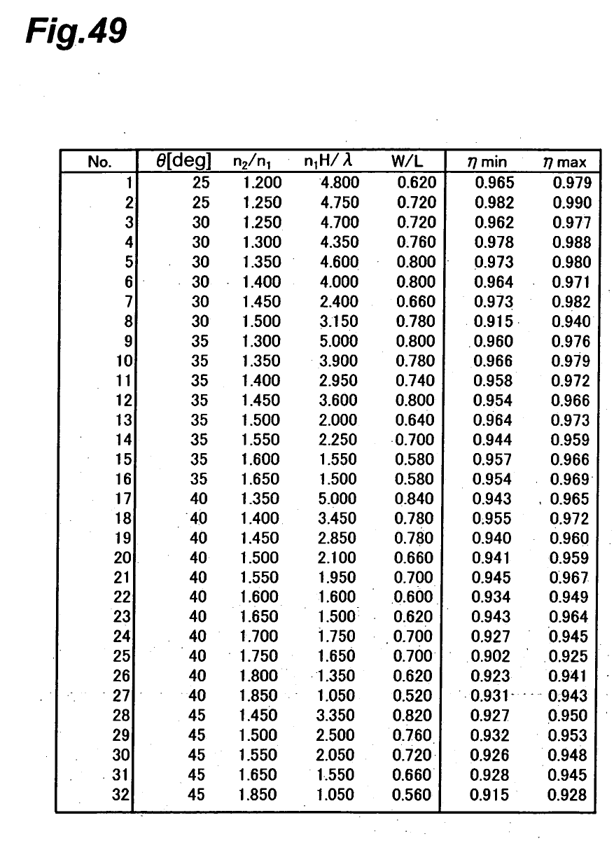

In the region satisfying the condition that ηₘᵢₙ≧0.90 while |ηₘₐₓ−ηₘᵢₙ|≦0.025, FIG. 49 shows values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 4 in order to convert the value of |ηₘₐₓ−ηₘᵢₙ| (0 to 0.025) into the same range as with the value of 1−ηₘᵢₙ (0 to 0.10), so that they can be compared with each other.

Thus, within C band, designing conditions of the transmitted type diffractive optical element 1 (combinations of parameters) in which each of respective diffraction efficiencies in TE and TM polarization modes became at least 0.85 or at least 0.90 while the difference between the maximum and minimum values of diffraction efficiencies in TE and TM polarization modes was not greater than 0.05 or not greater than 0.025 were found in simulation G.

Simulation H

In simulation H, in a manner substantially the same as simulation C, parameters (n₂/n₁, n₁H/λ, W/L, and θ) were changed as in simulation A, the light L1 is assumed to have a bandwidth in L band, and a simulation was carried out by using RCWA, whereby respective diffraction efficiencies η_{TE} and η_{TM} in TE and TM polarization modes of transmitted first-order diffracted light L3₁ were determined. Also, the maximum value ηₘₐₓ and minimum value ηₘᵢₙ of η_{TE} and η_{TM} in L band were determined.

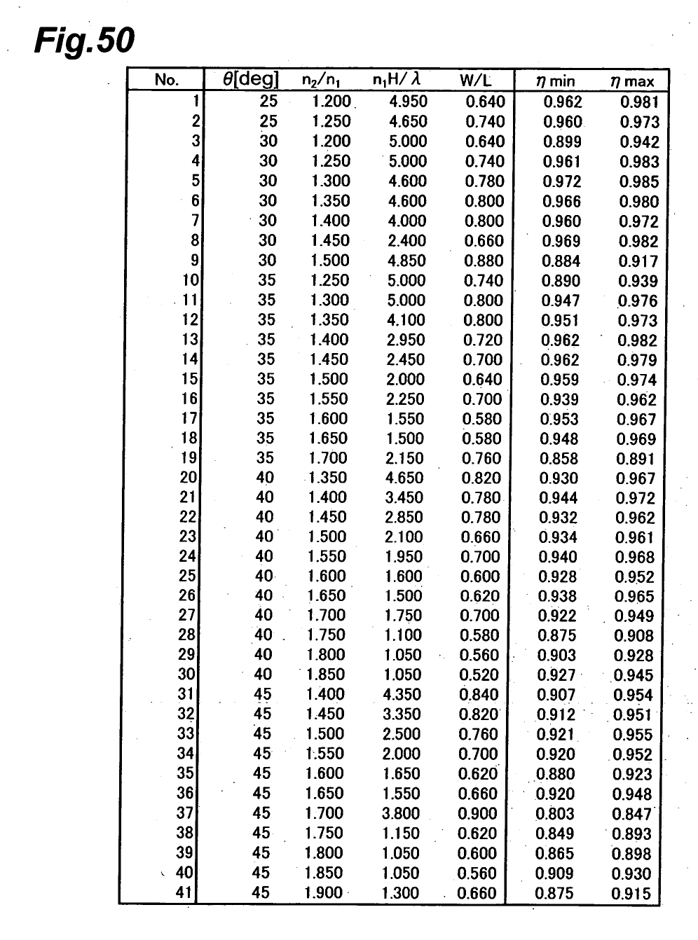

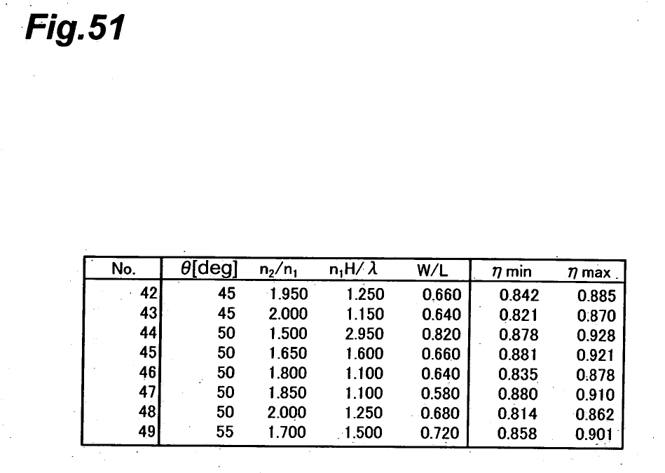

In the region satisfying the condition that ηₘᵢₙ≧0.80 while ηₘₐₓ−ηₘᵢₙ|≦0.05, FIGS. 50 and 51 show values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 4 in order to convert the value of |ηₘₐₓ−ηₘᵢₙ| (0 to 0.05) into the same range as with the value of 1−ηₘᵢₙ (0 to 0.20), so that they can be compared with each other.

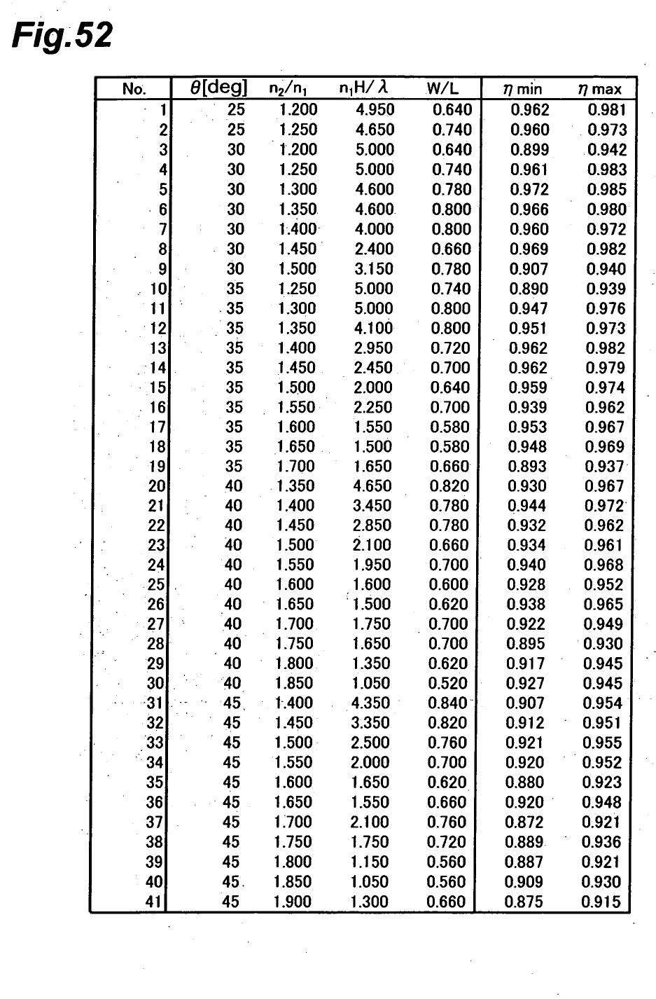

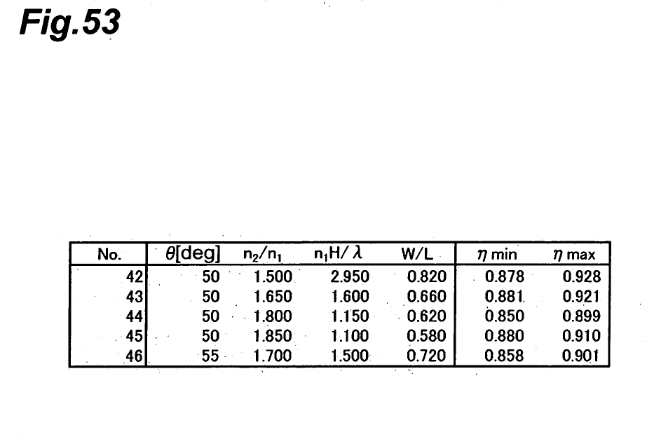

In the region satisfying the condition that ηₘᵢₙ≧0.85 while |ηₘₐₓ−ηₘᵢₙ|≦0.05, FIGS. 52 and 53 show values of parameters n₂/n₁, n₁H/λ, W/L, and e obtained when max(1−ηₘᵢₙ, 3|ηₘₐₓ−ηₘᵢₙ|) attains the smallest value, and values of Θₘᵢₙ and ηₘₐₓ at that time. Here, |ηₘₐₓ−ηₘᵢₙ| is multiplied by a coefficient value of 3 in order to convert the value of |ηₘₐₓ−ηₘᵢₙ| (0 to 0.05) into the same range as with the value of 1−ηₘᵢₙ (0 to 0.15), so that they can be compared with each other.

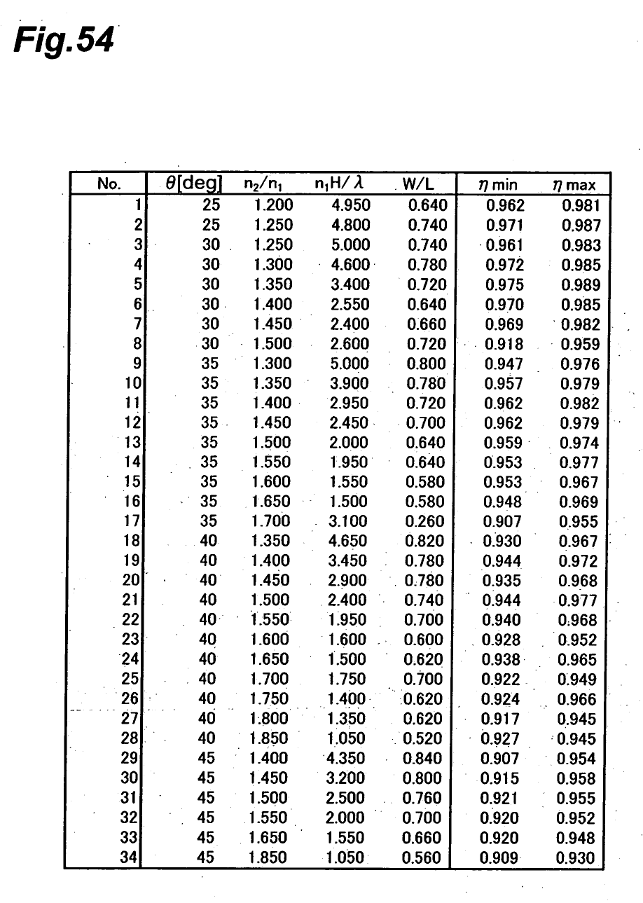

In the region satisfying the condition that Θₘᵢₙ≧0.90 while |ηₘₐₓ−ηₘᵢₙ|≦0.05, FIG. 54 shows values of parameters n₂/n₁, n₁H/λ, W/L, and θ obtained when max(1−ηₘᵢₙ, 2|ηₘₐₓ−ηₘᵢₙ|) attains the smallest value, and values of ηₘᵢₙ and ηₘₐₓ at that time. Here, |ηₘₐₓ−ηₘᵢₙ↑ is multiplied by a coefficient value of 2 in order to convert the value of |ηₘₐₓ−ηₘᵢₙ| (0 to 0.05) into the same range as with the value of 1−ηₘᵢₙ (0 to 0.10), so that they can be compared with each other.

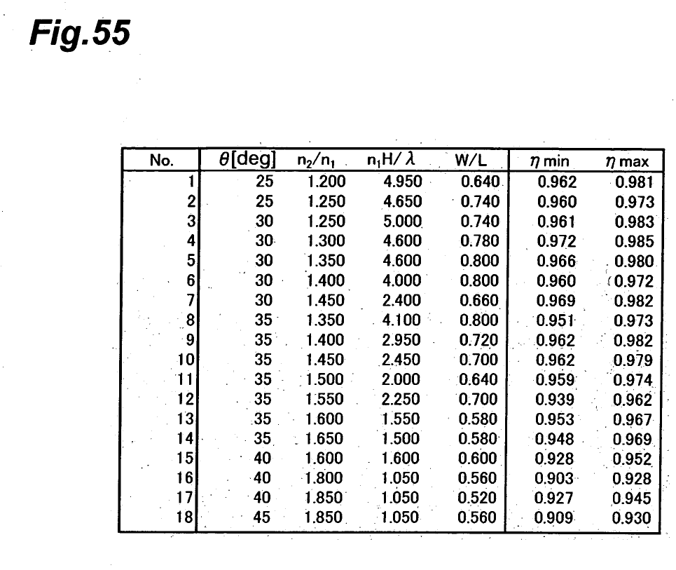

In the region satisfying the condition that ηₘᵢₙ≧0.90 while |ηₘₐₓ−ηₘᵢₙ|≦0.025, FIG. 55 shows values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 4 in order to convert the value of |ηₘₐₓ−ηₘᵢₙ| (0 to 0.025) into the same range as with the value of 1−ηₘᵢₙ (0 to 0.10), so that they can be compared with each other.

Thus, within L band, designing conditions of the transmitted type diffractive optical element 1 (combinations of parameters) in which each of respective diffraction efficiencies in TE and TM polarization modes became at least 0.80, at least 0.85, or at least 0.90 while the difference between the maximum and minimum values of diffraction efficiencies in TE and TM polarization modes was not greater than 0.05 or not greater than 0.025 were found in simulation H.

Simulation I

In simulation I, in a manner substantially the same as simulation C, parameters (n₂/n₁, n₁H/λ, W/L, and θ) were changed as in simulation A, the light L1 is assumed to have a bandwidth in both C and L bands, and a simulation was carried out by using RCWA, whereby respective diffraction efficiencies η_{TE} and η_{TM} in TE and TM polarization modes of transmitted first-order diffracted light L3₁ were determined. Also, the maximum value ηₘₐₓ and minimum value ηₘᵢₙ of η_{TE} and η_{TM} in C and L bands were determined.

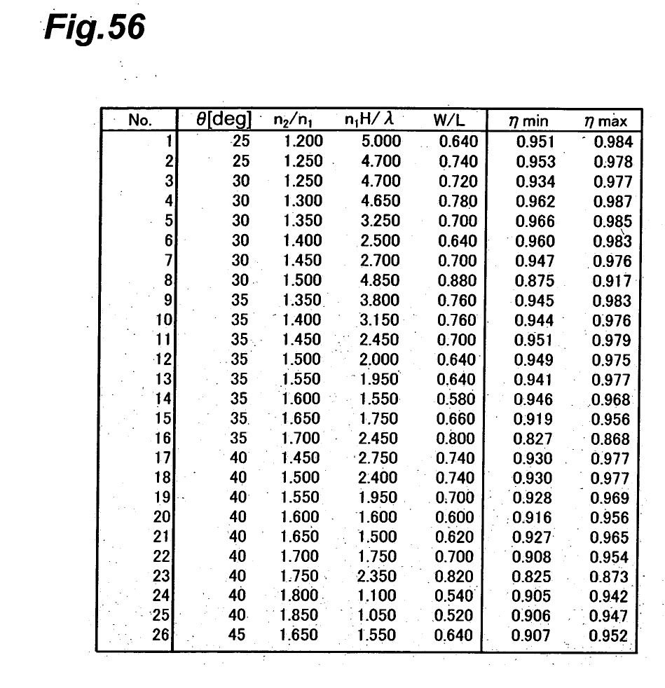

In the region satisfying the condition that ηₘᵢₙ≧0.80 while |ηₘₐₓ−ηₘᵢₙ|≦0.05, FIG. 56 shows values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 4 in order to convert the value of |ηₘₐₓ−ηₘᵢₙ| (0 to 0.05) into the same range as with the value of 1−ηₘᵢₙ (0 to 0.20), so that they can be compared with each other.

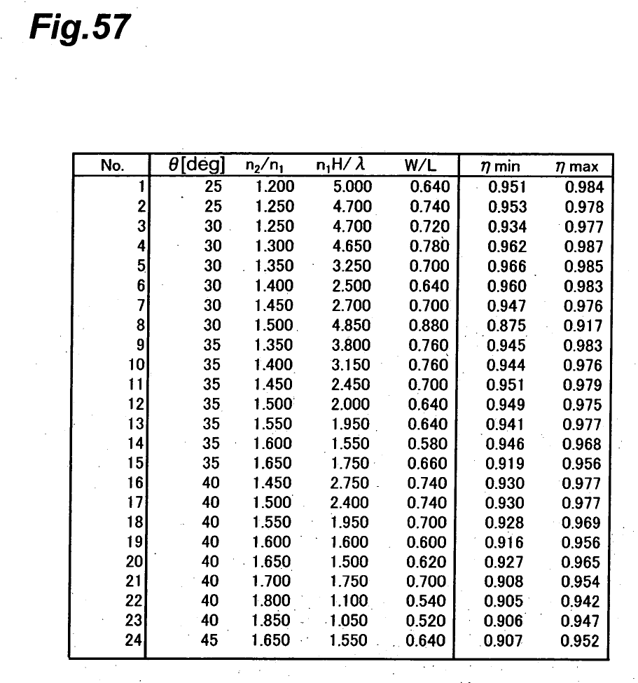

In the region satisfying the condition that ηₘᵢₙ≧0.85 while |ηₘₐₓ−ηₘᵢₙ|≦0.05, FIG. 57 shows values of parameters n₂/n₁, n₁H/λ, W/L, and θ obtained when max(1−ηₘᵢₙ, 3|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 3 in order to convert the value of |ηₘₐₓ−ηₘᵢₙ| (0 to 0.05) into the same range as with the value of 1−ηₘᵢₙ (0 to 0.15), so that they can be compared with each other.

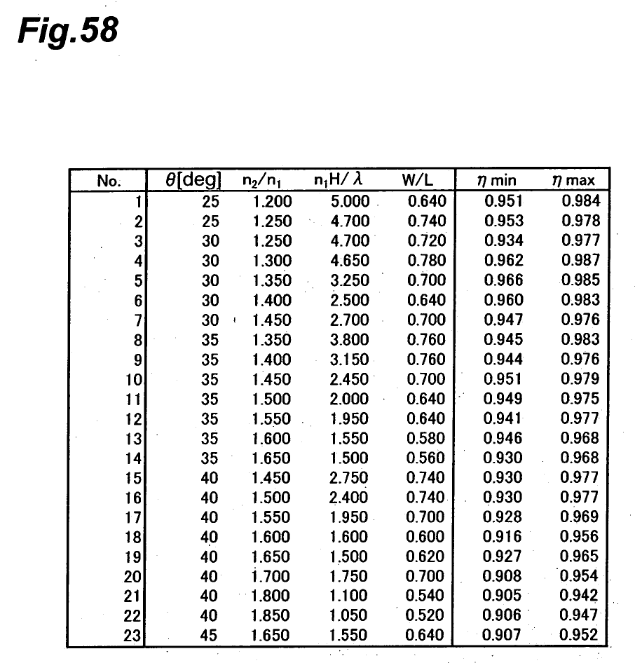

In the region satisfying the condition that ηₘᵢₙ≧0.90 while |ηₘₐₓ−ηₘᵢₙ|≦0.05, FIG. 58 shows values of parameters n₂/n₁, n₁H/λ, W/L, and θ obtained when max(1−ηₘᵢₙ, 2|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 2 in order to convert the value of |ηₘₐₓ−ηₘᵢₙ| (0 to 0. 05) into the same range as with the value of 1−ηₘᵢₙ (0 to 0.10), so that they can be compared with each other.

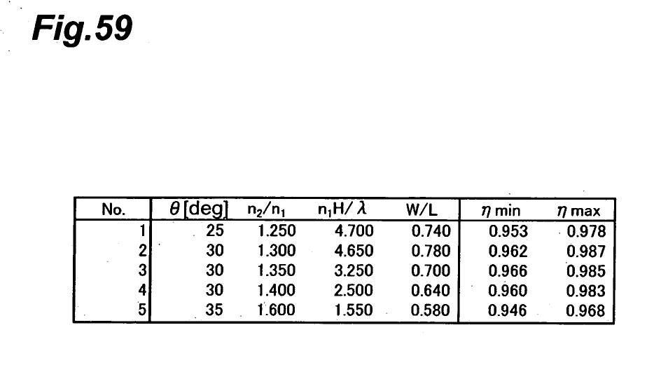

In the region satisfying the condition that ηₘᵢₙ≧0.90 while |ηₘₐₓ−ηₘᵢₙ|≦0.025, FIG. 59 shows values of parameters n₂/n₁, n₁H/λ, W/L, and θ obtained when max(1−ηₘᵢₙ, 4|ηₘₐₓ−ηₘᵢₙ|) attains the smallest value, and values of ηₘᵢₙ and ηₘₐₓ at that time. Here, |ηₘₐₓ−ηₘᵢₙ| is multiplied by a coefficient value of 4 in order to convert the value of |ηₘₐₓ−ηₘᵢₙ| (0 to 0.025) into the same range as with the value of 1−ηₘᵢₙ (0 to 0.10), so that they can be compared with each other.

Thus, within a bandwidth covering both C and L bands, designing conditions of the transmitted type diffractive optical element 1 (combinations of parameters) in which each of respective diffraction efficiencies in TE and TM polarization modes became at least 0.80, at least 0.85, or at least 0.90 while the difference between the maximum and minimum values of diffraction efficiencies in TE and TM polarization modes was not greater than 0.05 or not greater than 0.025 were found in simulation I.

As can be seen from simulations A to I, the transmitted type diffractive optical element 1 in accordance with this embodiment can raise the respective diffraction efficiencies η_{TE} and η_{TM} in TE and TM polarization modes of transmitted first-order diffracted light L3₁ to at least 0.8 (and further to at least 0.85 or at least 0.90), and can lower the polarization dependence and wavelength dependence of the transmitted type diffractive optical element 1.

There are cases where a transmitted type diffractive optical element is used with lenses, optical fibers, and the like, whereas other lenses may be used for correcting lens aberrations, positional deviations of optical fibers, and the like. For example, light emitted from an end face of an optical fiber is collimated by a lens, thus collimated light is diffracted by the transmitted type diffractive optical element according to wavelengths, and thus diffracted wavelengths of light are collected by another lens, so as to be made incident on an end face of another optical fiber. Here, the light incurs losses not only in the lenses but also at the time when incident on and emitted from the end faces of optical fibers. In such a case, it is preferred that each of the diffraction efficiencies η_{TE} and η_{TM} of transmitted type diffractive optical element be at least 0.85 or at least 0.90.

Also, there are cases where a transmitted type diffractive optical element is used with a mirror or the like. For example, the light diffracted by the transmitted type diffractive optical element is reflected by a mirror, and thus reflected light is diffracted by the transmitted type diffractive optical element again. Here, the light passes through the transmitted type diffractive optical element twice, thereby increasing the difference in diffraction efficiency between polarization modes. In such a case, it is preferred that each of the diffraction efficiencies η_{TE} and η_{TM} of transmitted type diffractive optical element be at least 0.90 and that the difference between the diffraction efficiencies η_{TE} and η_{TM} be 0.025 or less.

It will be more preferable if the angular dispersion D of transmitted first-order diffracted light in the transmitted type diffractive optical element is greater. In this case, the transmitted type diffractive optical element attains a greater wavelength separation, whereby an optical apparatus including the transmitted type diffractive optical element and other optical devices (e.g., light-receiving devices for receiving diffracted light, and optical fibers) can be made smaller. Therefore, it will be more preferable if the period L of diffraction grating is shorter. Preferably, the period L is 2.5 μm or less. This will now be explained. The angular dispersion D of transmitted first-order diffracted light in the transmitted type diffractive optical element is obtained when the diffraction angle φ is differentiated with the wavelength λ, and is given by the following expression:

D=|dφ/dλ|=|2 tan θ/λ| (3)

where θ is the incident angle.

Suppose that the medium is air (refractive index n₁=1) in wavelength-division multiple optical communications in C band at an optical frequency interval of 50 GHz (wavelength interval of 0.4 nm) whereas the other optical devices mentioned above are disposed with a pitch of 0.125 mm. If the incident angle θ is 30°, the angular dispersion D is 0.043°/nm, whereby a distance of about 420 mm is necessary-between the transmitted type diffractive optical element and the other optical devices. If the incident angle θ is 50°, by contrast, it will be sufficient if the distance between the transmitted type diffractive optical element and the other optical devices is about 200 mm, whereby the optical apparatus including the transmitted type diffractive optical element and the other optical devices can be made smaller.

As the period L of diffraction grating is shorter, the incident angle θ becomes greater, whereby the angular dispersion, D becomes greater, as can be seen from the above-mentioned expression (1). If the wavelength λ is not greater than the upper limit wavelength of U band (1625 nm to 1675 nm), the period L satisfying both of the above-mentioned expressions (1) and (2) is 2.5 μm or less. Namely, if the period L is not greater than 2.5 μm, the transmitted type diffractive optical element can diffract light having a wavelength of 1675 nm or less with a high angular dispersion, while satisfying both of the above-mentioned expressions (1) and (2).

The RCWA mentioned in the above-mentioned literature is one of theories used for designing/evaluating-one-dimensional transmitted type diffraction gratings. If the grating period is sufficiently greater than the wavelength of incident light, the theory of scalar-wave approximation holds. When the grating period approaches the wavelength of incident angle, however, the scalar wave approximation fails, thus making it necessary to handle the incident light as a vector wave. The RCWA slices a periodic structure along the depth thereof, makes respective coupled-wave equations in thus obtained layers, and adds a condition of continuity thereto, so as to determine respective solutions in incidence/reflection, transmission, and exit areas.

Though the light L1 is incident on the first surface 10a side (the side provided with the projections 20) of the transparent plate 10 in this embodiment, similar effects are obtained when the light L1 is incident on the opposite second surface 10b side (the side formed with the AR layer 30) of the transparent plate 10. Though the projections 20 are provided on the first surface 10a side in the transmitted type diffractive optical element 1 of this embodiment, depressions maybe provided instead of the projections 20.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A transmitted type diffractive optical element comprising a transparent plate formed with a diffraction grating, the transparent plate having first and second surfaces parallel to each other;
the first surface being in contact with a medium and formed with the diffraction grating, the second surface being provided with an antireflection film;
wherein, when light is incident on the first surface of the transparent plate from the medium, there are a wavelength λ and an incident angle θ of the light satisfying the correlation expressions of (2n₁L/λ)sin θ=1 and n₂/n₁≦3 sin θ, where n₁ is the refractive index of the medium, n₂ is the refractive index in the first surface of the transparent plate (n_{1<n}₂), and L is the period of the diffraction grating; and
wherein, at the wavelength λ and incident angle θ, transmitted first-order diffracted light in a TE polarization mode has a diffraction-efficiency η_{TE} of at least 0.8, and transmitted first-order diffracted light in a TM polarization mode has a diffraction efficiency η_{TM} of at least 0.8.

2. A transmitted type diffractive optical element according to claim 1, wherein the wavelength λ falls within a predetermined wavelength band, each of the diffraction efficiencies η_{TE} and η_{TM} being at least 0.8 in the whole predetermined wavelength band.

3. A transmitted type diffractive optical element according to claim 1, wherein each of the diffraction efficiencies η_{TE} and η_{TM} is at least 0.85 at the wavelength λ and the incident angle θ.

4. A transmitted type diffractive optical element according to claim 3, wherein the wavelength λ falls within a predetermined wavelength band, each of the diffraction efficiencies η_{TE} and η_{TM} being at least 0.85 in the whole predetermined wavelength band.

5. A transmitted type diffractive optical element according to claim 1, wherein each of the diffraction efficiencies η_{TE} and η_{TM} is at least 0.9 at the wavelength λ and the incident angle θ.

6. A transmitted type diffractive optical element according to claim 5, wherein the wavelength λ falls within a predetermined wavelength band, each of the diffraction efficiencies η_{TE} and η_{Tm} being at least 0.9 in the whole predetermined wavelength band.

7. A transmitted type diffractive optical element according to claim 1, wherein the diffraction efficiencies η_{TE} and η_{TM} have a difference of 0.05 or less therebetween at the wavelength λ and the incident angle θ.

8. A transmitted type diffractive optical element according to claim 7, wherein the wavelength λ falls within a predetermined wavelength band, maximum and minimum values of the diffraction efficiencies η_{TE} and η_{TM} having a difference of 0.05 or less therebetween in the whole predetermined wavelength band.

9. A transmitted type diffractive optical element according to claim 1, wherein the diffraction efficiencies η_{TE} and η_{TM} have a difference of 0.025 or less therebetween at the wavelength λ and the incident angle θ.

10. A transmitted type diffractive optical element according to claim 9, wherein the wavelength λ falls within a predetermined wavelength band, maximum and minimum values of the diffraction efficiencies η_{TE} and η_{TM} having a difference of 0.025 or less therebetween in the whole predetermined wavelength band.

11. A transmitted type diffractive optical element according to one of claims 2, 4, 6, 8, and 10, wherein the predetermined wavelength band includes C band.

12. A transmitted type diffractive optical element according to one of claims 2, 4, 6, 8, and 10, wherein the predetermined wavelength band includes L band.

13. A transmitted type diffractive optical element according to one of claims 2, 4, 6, 8, and 10, wherein the predetermined wavelength band includes both C and L bands.

14. A transmitted type diffractive optical element according to claim 1, wherein the period L of the diffraction grating is 2.5 μm or less.

15. A transmitted type diffractive optical element according to claim 1, wherein the wavelength λ falls within a wavelength band of 1.26 μm to 1.675 μm.
